(19) United States
(12) Patent Application Publication
(10) Pub. No.: US 2026/0036987 A1
(43) Pub. Date: Feb. 5, 2026

(54) DISTRIBUTED ZONE ALLOCATION AND PRESERVATION IN MULTI-AGENT SYSTEMS

(71) Applicant: UNIVERSITY OF SOUTH FLORIDA, Tampa, FL (US)

(72) Inventors: Tansel YUCELEN, Tampa, FL (US); Deniz KURTOGLU, Tampa, FL (US); Dzung TRAN, Dayton, OH (US); David W. CASBEER, Dayton, OH (US); Eloy GARCIA, Dayton, OH (US)

(21) Appl. No.: 19/290,326

(22) Filed: Aug. 4, 2025

Related U.S. Application Data
(60) Provisional application No. 63/678,925, filed on Aug. 2, 2024.
(60) Provisional application No. 63/678,937, filed on Aug. 2, 2024.
(60) Provisional application No. 63/678,951, filed on Aug. 2, 2024.

(51) Int. Cl. G05D 1/617; G05D 109/20

(52) U.S. Cl. CPC G05D 1/617; G05D 2109/20

(57) ABSTRACT

Methods and systems for generating control systems that can recognize and preserve zone allocation constraints in a multiagent system are disclosed. The methods and systems provide for determining a given agent's state within its current zone allocation, transforming the given agent's state into an unconstrained representation (e.g., using a mia-diffeomorphic mapping), determining a virtual control signal for the given agent based on the unconstrained representation, transforming the virtual control signal into an actual control signal via an inverse function, and communicating the actual control signal to the given agent based on a role of the agent and a communication protocol of the system. Other aspects, embodiments, and features are also claimed and described.

### CROSS-REFERENCE TO RELATED APPLICATION(S)

This application claims the benefit of U.S. Provisional Patent Application Ser. No. 63/678,925, filed Aug. 2, 2024, U.S. Provisional Patent Application Ser. No. 63/678,937, filed Aug. 2, 2024, and U.S. Provisional Patent Application Ser. No. 63/678,951, filed Aug. 2, 2024, the entire contents of which are hereby incorporated by reference in their entirety for all purposes, including all figures, tables, and drawings

### STATEMENT REGARDING FEDERALLY SPONSORED RESEARCH

This invention was made with government support under FA8650-21-D-2602 awarded by the Air Force Research Laboratory. The government has certain rights in the invention.

### BACKGROUND

Multiagent systems involve groups of agents that, in whole or in part, operate in concert toward certain collective goals. The agents may operate based on direct control from a master control unit (e.g., a base station, a leader agent, etc.), may operate through interacting with each other, or combinations thereof. Generally speaking, the agents typically involve some degree of autonomy: in other words, the agents may be given commands that define their actions, but may compute the particulars of how to implement those actions themselves. For example, an agent may be given a command to move in a given direction or to a given point, but then itself may calculate the specific motor inputs to cause a corresponding move, or may process information or otherwise act in an autonomous or semi-autonomous way toward a commanded goal.

Given the potential of these systems across a wide spectrum of civilian and military applications, their significance has notably increased. However, approaches to guiding their actions still have sever deficiencies. In some cases, an approach is taken in which agents communicate controls and commands among one another (or determine actions based on the actions of other agents in the group). Approaches of this type can sometimes be known as ‘distributed control protocols’, which are designed to facilitate local interactions among agents. Some distributed control protocols employ graph theory to create scalable solutions suitable for large groups of agents. However, these protocols encounter several difficulties and situational limitations.

One problem that has thus far not be suitably solved is how to address multi-agent control in systems where each agent is allocated a zone and should retain a state falling within that zone. Typical distributed control problems involve consensus and bipartite consensus in the leaderless setting; and pinning, containment, and formation in the leader-follower setting. A common characteristic among these problems is the assumption that agents operate without being subject to specific state constraints. Consequently, they are not directly applicable to the zone allocation and preservation problems. The concept of “zone allocation” involves assigning specific zones (i.e., state constraints) to each agent, while the concept of “zone preservation” involves attempts to ensure that each agent remains within their designated zone throughout the pursuit of a collective goal.

A wide spectrum of applications from surveillance and reconnaissance to traffic management and precision agriculture benefit from zone allocation and zone preservation. However, previous control attempts exhibited disadvantageous limitations or unreliability, such as not being able to assign zones to agents unless the zones contain the ‘origin’ in a set of possible states or being limited to only certain leader-follower topographies.

Thus, it would be desirable to have a reliable and readily usable approach to address the zone allocation and preservation problems in multi-agent system control scenarios of a variety of types.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the present disclosure, methods, systems, and apparatus for improved generation of commands for individual agents in a multiagent system are disclosed. These methods, systems, and apparatus can include steps and/or components allowing for use of control approaches or algorithms that would typically assume an unconstrained state space, in multiagent systems in which agents may have known, bounded, or otherwise constrained state spaces. These methods, systems, and apparatus can also include steps and/or components allowing for agents to follow commands and/or targets, without leaving their respective zones.

For example, in one aspect, a method is provided for operating a multi-agent system via control signals that preserve constraints of zone allocations of the system, comprising: providing a group of agents to collectively comprise the multi-agent system, the agents configured to perform functions within designated zones and to communicate via a given peer to peer command protocol; detecting a circumstance warranting a given command to be sent to a given agent, the command comprising a time-varying target state for the given agent; determining a current, bounded zone allocation for the given agent, the bounded zone allocation including a constraint defining a region within which a state of the given agent is to be maintained during operation of the multi-agent system; determining a current role and a current state of the given agent within the bounded zone allocation, based on at least one of a sensor output or information provided by one or more agents of the multi-agent system; transforming the current state of the given agent from the bounded zone allocation to an unconstrained representation using a monotonically increasing aligned diffcomorphic (mia-diffcomorphic) map; generating a virtual control signal for the given agent to implement the command, using a distributed adaptive control protocol and the unconstrained representation of the given agent's current state; transforming the virtual control signal into an actual control signal for the given agent by applying an inverse of a derivative of the mia-diffcomorphic map to the virtual control signal; transmitting the actual control signal for execution by the given agent, via a transmission formatted according to the current role of the given agent and the command protocol of the multi-agent system; observing the given agent's behavior to confirm implementation of the command, such that if the command signal is within the bounded zone allocation the agent should be observed moving to the command, and if the command signal is not within the bounded zone allocation the agent should be observed maintaining proximity to the command signal while remaining within the bounded zone allocation; and updating a zone allocation of at least one agent of the system based on the given agent behavior.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods, it should be understood that such example embodiments can be implemented in various devices, systems, and methods.

### BRIEF DESCRIPTION OF THE DRAWINGS

FIG. 1 is a conceptual diagram of an example implementation of a mia-diffeomorphic map approach, according to some embodiments.

FIG. 2A is a conceptual graph of an example of constrained states of an agent in a one-dimensional setting.

FIG. 2B is a conceptual graph of an example of constrained states of an agent in a two-dimensional setting.

FIG. 3 is a graph of example closed-loop multiagent commands and responses in accordance with some embodiments.

FIG. 4A is a graph of example control histories for agents along an x-axis, in accordance with some embodiments.

FIG. 4B is a graph of example control histories for agents along a y-axis, in accordance with some embodiments.

FIG. 5 is a comparative graph of examples of individual closed loop responses for a group of agents and associated commands, according to some embodiments.

FIG. 6A is a graph of example control histories for agents along an x-axis, in accordance with some embodiments.

FIG. 6B is a graph of example control histories for agents along a y-axis, in accordance with some embodiments.

FIG. 7 is a flowchart illustrating an example process for command generation for one or more agents in a multiagent system, according to some embodiments.

FIG. 8 is a block diagram showing connections and data/command exchanges among agents and/or a control station of a multiagent system.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

Thus, the present disclosure comprises general descriptions of methods that can leverage the advantageous concepts disclosed herein; general descriptions of devices, equipment, and network layouts that can implement and deploy such methods and concepts; and a discussion of specific validations performed by the inventors for some illustrative examples.

The term “multi-agent” is utilized in reference to characteristics of systems for which these methods, concepts, systems and examples may be applicable. In some embodiments, a “multi-agent” system can include a computerized system that comprises multiple interacting, intelligent agents (e.g., individual devices or processes that perform tasks toward a collective group or system goal). The interacting agents may be used, for example, to perform surveillance of areas that would be difficult or impossible for humans or individual devices to monitor, or to solve problems that are difficult or impossible for an individual agent or a monolithic system to solve. Examples of multiagent systems are groups of interacting aerial drones, groups of agentic software systems monitoring aspects of signals or data, and various physical, logical, and/or robotic agents that can interact with one another.

### Example Processes, Algorithms, and Methods

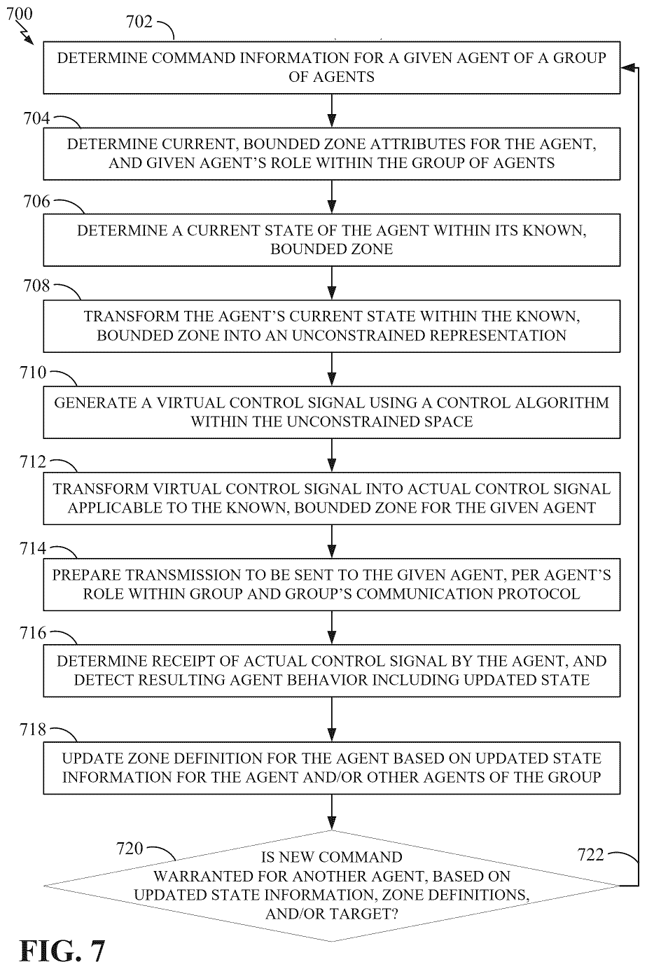

Referring now to FIG. 7, an example process is shown by which an improved approach or algorithm may be implemented for improved generation of commands and/or control signals for a given agent of a multi-agent system. Thus, FIG. 7 should be understood as contemplating an example process 700 for controlling and/or guiding a single agent or a group of agents in a way that accounts for (and honors) zone allocation and preservation in a multiagent system, using a novel state transformation and distributed adaptive control protocol, as described herein. Process 700 may be implemented by a computing system or controller operatively coupled to a plurality of agents (e.g., autonomous vehicles, mobile robots, drones, or other distributed agents) communicating over a network. The process may be realized as a set of software modules, firmware routines, or hardware logic circuits, and may execute in a centralized, decentralized, or distributed manner, depending on the application and system architecture.

At block 702, process 700 may determine command information for a given agent of a group of agents. In some embodiments, this command information may comprise a time-varying reference signal or target state (e.g., position, velocity, or other operational parameter) that is intended to guide the agent's behavior. The command may be generated by a supervisory controller, a leader agent, or derived from mission objectives, environmental sensing, or operator input.

In some examples, a device or resource that operates process 700 may have determined that a command should be sent to a given agent. The substance, objective, or goal of the command signal may be system-dependent (e.g., based on the types of agents involved, and their capabilities like aerial motion for example) and/or may be mission-dependent (e.g., optimizing coverage of agricultural surveillance drones by causing them to spread out over a large acreage).

The timing, scope, and content of the command may be determined according to a variety of methods, depending on the operational context and requirements of the multiagent system. In some embodiments, the command may be generated based on external target tracking, wherein the system detects the state of a moving object or environmental feature of interest—such as a vehicle, person, or dynamic obstacle—using onboard or distributed sensors of one or more of the agents of the system (e.g., radar, lidar, cameras, or other environmental detectors). The detected state of the target or feature, such as position, size, topography, and/or velocity, may then be processed to yield a time-varying command signal to be given to the agents (e.g., to cause them to follow, avoid, intercept, or maintain some proximity to the target). Such approaches may be relevant in, for example, surveillance, pursuit-evasion, or search-and-rescue applications.

Alternatively, the command may be provided directly by a human operator or supervisory system, such as through manual input, graphical user interface, or pre-programmed mission plans. In other embodiments, the command may be computed by a mission planning or optimization module, which generates reference trajectories or setpoints based on global objectives, resource constraints, or desired coverage patterns. For distributed or fully autonomous systems, the command may emerge from consensus or distributed estimation algorithms, where agents collectively compute a reference state or trajectory by sharing local observations and iteratively updating their estimates.

Further, the command may be generated in an event-driven or condition-based manner, such that certain environmental or system triggers—such as detection of an obstacle, change in mission phase, or threshold crossing—result in the issuance of a new or updated command. In advanced embodiments, learning-based or adaptive algorithms may be employed, allowing the command to be dynamically adjusted in response to real-time data, historical patterns, or predicted future states. Hybrid approaches are also contemplated, wherein multiple command generation strategies are combined or switched between as operational circumstances dictate. Thus, the process is sufficiently general to accommodate a wide range of command generation methodologies, making it applicable to diverse multiagent system scenarios.

The command information may further include limitation or constraint attributes such as boundedness (i.e., the command remains within a known range), a bounded time rate of change (i.e., the command does not change arbitrarily fast), and temporal or spatial constraints.

At block 704, process 700 determines the current, bounded zone attributes for the given agent that will receive the command, as well as the agent's role within the group of agents. The bounded zone attributes may comprise a user-defined or dynamically computed interval or region (e.g., an interval of values in one dimension, or a 2D range of values (e.g., in an x,y plane), or a 3D or multi-sided area or volume in higher dimensions, or combinations thereof where multiple attributes or multiple states have bounds) within which the agent's state is to be maintained at all times. The zone may be part of a heterogeneous set of agent zones (i.e., it may be different than a zone or zones of other agent, in terms of size, range, characteristics, etc.), part of a homogenous set of agent zones, may or may not include the origin, and may be intersecting or disjoint with respect to the zones of other agents. The agent's role may be classified as leader, follower, or other specialized designation (e.g., relay, observer, or coordinator), and may determine the agent's access to command information, the manner in which it may receive the command, and the command's influence on the group's collective behavior. In some embodiments, the agent's role and zone attributes may be assigned statically (e.g., at system initialization), dynamically (e.g., in response to mission phase or environmental changes), or via negotiation among agents.

At block 706, process 700 determines a current state of the agent within its known, bounded zone. The current state may include the agent's position, velocity, orientation, or other relevant state variables, sensed or estimated at the present time. The state may depend upon the nature of the agent itself (whether a physical device that operates in 3D space like an aerial drone, a physical device that operates in 2D space like an autonomous vehicle on a given roadway or track, or a virtual agent that operates in a given data space). The state may be obtained from onboard sensors, state estimators, or communicated by other agents or a central controller. In some embodiments, the state may be multi-dimensional, and the determination may include validation that the state lies within the prescribed zone (e.g., via boundary checking). If the agent's state is near or at the boundary of its zone, special handling may be triggered, such as adjustment of control effort or redefinition of the zone boundaries to ensure safety or constraint satisfaction. The state information may also be timestamped and associated with metadata such as agent ID, confidence level, or quality of measurement. In some embodiments, the state information may include the given agent's perception or detection of other nearby agents (or all agents) of the group, such as through onboard sensors-which can be used to perform state checking for more than simply the given agent's own state.

In some embodiments, blocks 702-706 may be performed in alternative orders or at the same time.

At block 708, process 700 transforms the agent's current state within the known, bounded zone into a representation of the state in an unconstrained space. Thus, as described in more detail below, the constraints associated with a system's zone allocation and zone preservation rules can be transformed in a way that will allow for classical control algorithms (which might assume unconstrained space) to help generate a control signal according to the determined/desired command. In some embodiments, this transformation is performed using a monotonically-increasing, aligned, diffcomorphic (mia-diffcomorphic) map, as described in Definition 2 and Remark 1 below. In other words, an actual state x_i(t)∈S_i is mapped to an unconstrained variable z_i(t)∈ [symbol] via a composite function, which in some implementations may comprise a smooth, one-to-one mapping that steadily increases and matches the original state values within a central portion of the zone, while ensuring the transformation preserves order, invertibility, and continuity throughout the entire zone. Stated in another way, the composite fuction (e.g., mia-diffcomorphic mapping function) comprises a smooth, invertible, and order-preserving mapping that matches an identity function within an interior portion of the bounded zone allocation for a given agent. The transformation thus can ensure that a control signal based on the unconstrained variable can be determined using standard control techniques without explicit state constraints, while the inverse transformation can ensure that the actual agent state remains within its designated zone. In some embodiments, the transformation parameters (e.g., transition region width, alignment interval) may be selected adaptively based on zone geometry, agent dynamics, or safety margins. Alternative transformations (e.g., other diffeomorphic or homeomorphic mappings) that satisfy such properties for constraint enforcement may also be used.

At block 710, process 700 generates a virtual control signal using a control algorithm within the unconstrained space. In one embodiment, this control algorithm is a distributed adaptive protocol that operates on the transformed variables z_i(t), as described in equation (6) below. The virtual control signal may be computed based on the agent's own state, the states of neighboring agents (as defined by a communication graph), the command information, and adaptive terms that compensate for unknown or time-varying command rates. The protocol may include proportional, consensus, or containment terms, as well as other information to ensure stability, accuracy, convergence and robustness. The adaptive component may be updated according to an adaptation law (e.g., equation (7)), which may include leakage, forgetting, or normalization to prevent unbounded growth. In alternative embodiments, the control algorithm may be centralized, hierarchical, or employ model predictive or learning-based elements. However, it is contemplated that other control algorithms may be utilized, as suitable to the given system of agents, the given goal or mission, etc.

At block 712, process 700 transforms the virtual control signal into an actual control signal applicable to the known, bounded zone for the given agent. In some examples, this may be accomplished by applying an inverse of the state transformation, such as an inverse of the state transformation's derivative (i.e., the Jacobian of the mia-diffcomorphic map) to the virtual control signal, as shown in equation (4). The resulting actual control signal u_i(t)∈ [symbol] can thus respect the agent's state constraints: as the agent approaches the boundary of its zone, the control effort naturally vanishes, preventing violation of the constraint. In some embodiments, the transformation may be performed numerically or analytically, and may be augmented with other adaptations or filters. In multi-dimensional settings, the transformation may be applied component-wise or via a multi-variate extension of the mia-diffeomorphic map.

At block 714, process 700 prepares a command transmission to be sent to the given agent, per the agent's role within the group and conforming to the group's communication protocol. In some embodiments, the command transmission may include the actual control signal, updated state or zone information, and/or auxiliary data such as timestamps, agent identifiers, or error signals. The communication protocol may be synchronous or asynchronous, and may employ broadcast, multicast, or unicast modes, depending on network topology and bandwidth constraints. Thus, process 700 may take into account the organization of the multi-agent system or group overall, plus the current role of the given agent, to determine how to format the command transmission. In other words, the command transmission may be developed to account for whether it will be retransmitted by another agent or multiple agents, may be sent to the nearest agent or only to a leader agent, or directly to the given agent. As noted above, in dynamic systems the role of the given agent may vary based on environmental or mission factors, and so the format of the command transmission can be determined automatically in real time based on the obtained and/or stored agent role information for one or more agents of the group.

The protocol may support reliability features such as acknowledgement, retransmission, or error correction, and may be implemented over wired, wireless, or hybrid links. In leader-follower architectures, the transmission may be routed through leader agents or relays, while in fully distributed systems, peer-to-peer communication may be employed. In some embodiments, the transmission may be encrypted or authenticated to ensure security and integrity.

Furthermore, the command transmission may be developed so that it will be received by, or influence, multiple other agents. For example, where agents of a given system are programmed to respond to behavior or signals from other agents, a flag or other control hierarchy information may be included in the command transmission to signify to the other agents that the new behavior of the given agent was instructed by an authoritative source (and not, e.g., simply a transient environmental response) so that the other agents can conform or change their roles and/or objectives accordingly.

At block 716, process 700 determines receipt of the actual control signal by the given agent, and detects resulting agent behavior, including updated state information for one or more agents. Receipt may be confirmed via acknowledgement messages, timeouts, or periodic status updates from the agent. The process may monitor the agent's response to the control signal by acquiring new state measurements, estimating the effect of control actions, or detecting anomalies (e.g., failure to move, excessive control effort, or constraint violation). In some embodiments, the process may also aggregate state information from multiple agents to assess collective behavior, detect emergent patterns, or identify agents requiring assistance or reconfiguration. The updated state information may be logged for auditing, performance analysis, or learning purposes.

At block 718, process 700 optionally updates the zone definition for at least one agent based on the updated state information for the given agent and/or other agents of the group. Zone updates may be triggered by a variety of factors, including agent movement, environmental changes, mission progress, or policy updates. For example, zones may be expanded, contracted, shifted, or reallocated to accommodate obstacles, avoid collisions, maintain coverage, or optimize resource utilization. The update may be performed autonomously by the agent, by a supervisory controller, or via negotiation among agents. In some embodiments, the updated zone definition may be communicated to relevant agents or controllers, and the state transformation parameters may be recalculated accordingly. The update may also trigger recalibration of the control protocol, adaptation of communication patterns, or re-assignment of agent roles.

At decision block 720, process 700 optionally determines whether a new command is warranted for another agent, based on the updated state information, zone definitions, and/or target or goal information. This decision may involve evaluating whether the current objectives have been met, whether new goals have arisen, or whether reallocation of tasks or resources is necessary for optimal group performance. If a new command is warranted (e.g., another agent needs to follow a new trajectory, respond to a disturbance, or assume a new role), the process reverts to block 702 and generates a new command for the selected agent. Otherwise, the process may terminate, idle, or continue monitoring for further events. In some embodiments, the determination may be made using rule-based logic, optimization criteria, consensus among agents, or supervisory input. The process may also support batch or parallel updates for multiple agents, as well as event-triggered or periodic execution.

The foregoing blocks of process 700 may thus be iterated continuously or on demand, and may be implemented in part or in whole by agents themselves, a centralized controller, or a distributed computing infrastructure. The process is thus compatible with a wide range of agent types, zone geometries, communication protocols, and control objectives, and may be extended to multi-dimensional, high-order, or uncertain agent dynamics. In alternative embodiments, the process may further include steps for initialization, safety monitoring, failure recovery, or learning-based adaptation.

### Example Implementations, Configurations, and Applications

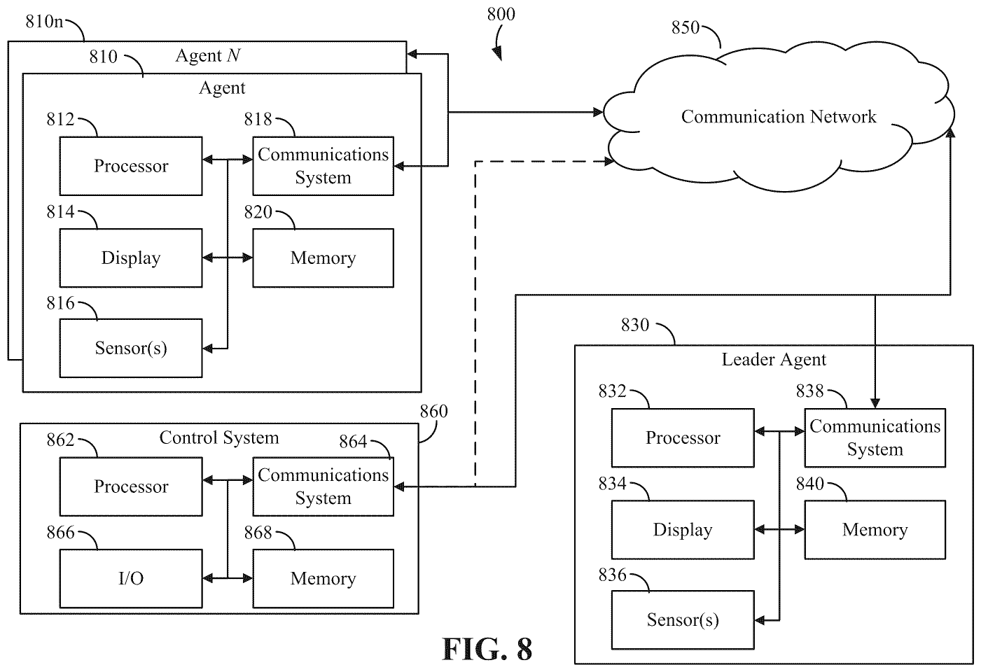

Referring now to FIG. 8, a block diagram is shown depicting example equipment, configurations, and communications among agents of a multi-agent system 800. For example, the multiagent system 800 can include one or more agents (i.e., follower agents) 810-810n and one or more leader agents 830. In some examples, the one or more agents 810-810n and the one or more leader agents 830 can communicate directly among themselves via a communication network 850, and/or with a separate control system 860 via communication network 850 or directly.

In some examples, the agents 810-810n can transmit or receive information (e.g., the status of the agent 810-810n) over the communication network 850. In some examples, the communication network 850 can be any suitable communication network or combination of communication networks. For example, the communication network 850 can include a Wi-Fi network or similar local Wi-Fi-type local broadcast network (in which case the individual agents 810-810n, and 830 can include one or more wireless transceivers, routers, one or more wireless switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, 5G, etc.), a wired network, etc. In some embodiments, communication network 850 can be a local area network, a wide area network, a public network (e.g., the Internet), a private or semi-private network (e.g., a corporate or university intranet), any other suitable type of network, or any suitable combination of networks. Communications links directly among follower agents 810-810n, between agents 810-810n and leader agents 830, and/or between leader agents 830 can each be any suitable communications link or combination of communications links, such as wired links, fiber optic links, Wi-Fi links, Bluetooth links, cellular links, etc.

In further examples, the agent 810-810n and/or a leader agent 830 can be a vehicle (e.g., a ground vehicle, an aerial vehicle, an underwater vehicle, a ship, a space vehicle, an autonomous vehicle, a motor vehicle, a space vehicle, car, a train, an unmanned aerial vehicle, a rocket, or a missile, etc.) or any other suitable apparatus or means (e.g., a computing circuit or chip, virtual or software node, software-based agent or subroutine, etc.). The follower agents 810-810n can include any suitable computing device or combination of devices, such as a processor (including an ASIC, DSP, FPGA, GPU, CPU, or other processing component) desktop computer, a laptop computer, a smartphone, a tablet computer, a wearable computer, a server computer, a computing device integrated into the vehicle, a camera, a robot, a virtual machine being executed by a physical computing device, etc.

In further examples, the agents 810-810n can include a processor 812, a display 814, one or more sensors or other inputs 816, one or more communication systems 818, and/or memory 820. In some embodiments, the processor 812 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. In some embodiments, the optional display 814 can include any suitable display devices, such as a computer monitor, a touchscreen, a television, an infotainment screen, projector, depth camera, etc. In some embodiments, the sensor(s) 816 can include accelerometers, gyroscopes, and other IMU devices; barometers and other altimeters; magnetometers and other orientation/navigation sensors; radar, lidar, ultrasonic range, and other velocity or position sensors relative to environment; optical cameras, infrared cameras, and other similar sensors; temperature sensors, vibration sensors, microphones, and other sensors for monitoring internal systems and component performance; environmental sensors (e.g., wind, humidity, etc.); GPS/GNSS systems; radio receivers, RFID, NFC, and other electromagnetic sensors; and any other suitable sensors or inputs for the given task of the agent.

In further examples, the communications system 818 can include any suitable hardware, firmware, and/or software for communicating information over communication network 850 and/or any other suitable communication networks (e.g., via cellular or long range radio communication to a control system 860). For example, the communications system 818 can include one or more transceivers, one or more communication chips and/or chip sets, etc. In a more particular example, the communications system 818 can include hardware, firmware and/or software that can be used to establish a Wi-Fi connection, a Bluetooth connection, a cellular connection, an Ethernet connection, etc. to transmit the status of the agent 810-810n, receive the status of one or more neighboring agents 810-810n, 830, or communicate with the control system 860.

In further examples, the memory 820 can include any suitable storage device or devices that can be used to store software to operate the agent as well as store the status of the agent 810-810n, status of the one or more neighboring agents 810-810n, 830, data, instructions, values, etc., that can be used, for example, by the processor 812 to perform actions of the agent 810-810n (e.g., movements, sensing, etc.). The memory 820 can include any suitable volatile memory, non-volatile memory, storage, or any suitable combination thereof. For example, memory 810 can include random access memory (RAM), read-only memory (ROM), electronically-erasable programmable read-only memory (EEPROM), one or more flash drives, one or more hard disks, one or more solid state drives, one or more optical drives, etc. In some embodiments, the memory 820 can have encoded thereon a computer program for controlling operation of computing device 812. For example, in such embodiments, the processor 812 can execute at least a portion of the computer program to perform one or more processes described herein, transmit/receive information via the communications system 818, etc. As another example, processor 612 can execute at least a portion of process 700 described above in connection with FIG. 7 and/or provide information to/communicate with another processor operating process 700.

In even further examples, the multiagent system can include one or more leader agents 830. A leader agent 830 can include a processor 832, a display 834, sensors or other input(s) 836, a communication system 838, and/or a memory 840. In some examples, the processor 832, the display 834, the input(s) 836, the communication system 838, and/or the memory 840 of the leader 830 are substantially similar to those in the agent 810-810n. In addition, the leader 830 may have software stored on memory 840 that, when executed by processor 832, causes the agent 830 to receive and process a bounded time-varying command (c(t)) for it to follow and/or for it to disseminate to the one or more agents 810-810n. In some examples, the one or more agents 810-810n may not access or know the command (c(t)), but rather may behave in accordance with the command due to behavior of the leader agent 830 in response to the command. In other examples, the command (c(t)) can be available to the one or more agents 810-810n.

In yet further embodiments, a separate control system 860 may be used in system 800. (In other configurations, the operation of control system 860 may instead or also be performed by a leader agent 830 and/or by any or all agents 810-810n, 830.) The control system 860 may comprise a processor 862, an input/output system 866 (e.g., displays, keyboards, etc.), a communication system 864, and/or a memory 868. In certain configurations, control system 860 may be deployed as a base station that transmits control signals over long distances to aerial or robotic drones. In other configurations, control system may be a server or other processing resource that processes sensor inputs from agents 810-810n, 830 and/or other sensors (e.g., environmental sensors for a warehouse, industrial facility, hospital, etc.) to make classifications, predictions, process large amounts of data, and/or perform other higher-order determinations that influence what the multi-agent system should do and what commands should be issued to the agents.

Therefore, from the general depiction of components and agents of system 800, a number of specific use cases, physical implementations, and applications can be contemplated.

For example, in some embodiments, the processes and systems described herein may be implemented as a system for coordinating, controlling, and/or guiding a swarm of aerial drones for surveillance, mapping, or environmental monitoring applications. In such a scenario, each drone may function as an agent (810-810n) and may be equipped with a suite of sensors as described above (e.g., GPS, IMU, cameras, lidar, barometer, and communication modules), enabling it to determine its own state, to communicate with other drones and/or a leader agent 830 via the communication network 850, and to sense environmental characteristics. An optional leader drone or a remote control system 860 may generate a time-varying command, such as a search pattern, tracking a moving target, or following a dynamically updated area of interest. Using process 700, each drone receives zone allocations—such as specific airspace corridors or altitude bands—to avoid collisions and maximize coverage, and applies the state transformation and adaptive control protocol to ensure it remains within its assigned zone while responding to the collective mission command.

In this aerial swarm use case, it may be desirable to dynamically change the drones' states and/or zones based on environmental changes (e.g., wind, obstacles, no-fly zones), detected anomalies (e.g., a bird, another drone, a fire, a group of people on the ground nearby, etc.), or the loss/addition of swarm members. The communication network 850 allows for rapid dissemination of updated states and commands, enabling the swarm to reconfigure in real time. For example, if a leader drone detects a target moving into a new area, it can transmit an updated command to the swarm, and each drone will adapt its state and control actions to maintain coverage and zone preservation. The leader (or control system) can thus use a variety of control algorithms to generate the control commands for each agent, subgroups of agents, or all agents, while preserving the notion of zone allocation and preservation.

In another contemplated example, the systems and methods disclosed herein may be employed via a system of facility monitoring devices, which may include mobile and/or stationary monitoring devices, devices that can both monitor and mitigate safety concerns, or both. In some cases, the devices may be given zones to monitor within a warehouse or large industrial facility. The agents 810-810n may include autonomous ground robots, stationary sensor nodes, and mobile cameras, each assigned to monitor specific zones for hazards such as smoke, fire, water leaks, unauthorized access, or displaced merchandise or materials. The leader agent 830 or centralized control system 860 may issue commands based on real-time sensor data, such as directing robots to investigate an alarm, deploy fire suppression, or capture images of an intruder. Using process 700, each agent maintains its operation within assigned safety zones, dynamically reallocating coverage as conditions change (e.g., closing off a fire-affected area or focusing resources on a detected anomaly). For example, if a fire is detected in a given zone, devices near that zone may monitor for spread of the fire, while devices distant from that zone may be prescribed a new zone that overlaps with the zone containing the fire to assist with suppression while avoiding collision with other devices in the area.

In this warehouse safety use case, the agents can communicate over a robust network 850, sharing their state (e.g., position, lack of detected safety issues, etc.), detected hazards, and operational status. The distributed control protocol enables agents to coordinate responses, such as dispatching the nearest robot to extinguish a fire, rerouting other agents to avoid danger, or collaborating to clear blocked aisles-all while taking into account the zone allocations of each device so that a sufficient number of devices can remain within their zones to provide continued monitoring and/or safety coverage. The system can also generate alerts for human operators via displays or mobile devices, and log all actions and sensor data for compliance and post-incident analysis. The architecture can support both autonomous and semi-autonomous operation, allowing for seamless integration of manual overrides or supervisory interventions as needed.

In further embodiments, the processes and systems described herein may be implemented in a virtual environment comprising a network of software-based agents operating within a network, such as the network(s) of a large healthcare organization. In this scenario, each agent 810-810n may be instantiated as a validated process or subroutine assigned to monitor, analyze, or process specific streams of data-such as electronic health records, billing transactions, staffing schedules, or resource inventories. The leader agent 830 or control system 860 may direct the flow of information or trigger specific analyses based on organizational priorities or detected anomalies (e.g., potential fraud, unusual billing patterns, or sudden shifts in patient volume).

Applying process 700, each virtual agent operates within a defined “zone” of data or responsibility (e.g., certain departments, types of patient/private records, or time intervals), ensuring that sensitive data is only accessed by authorized processes and that analytic tasks are distributed efficiently. When an agent detects a pattern of interest—such as a possible instance of fraud or a predicted resource shortfall—it can generate a summary or alert for review by other agents or human supervisors. The communication network 850 in this case may comprise secure internal messaging or data bus infrastructure, allowing agents to share findings, escalate issues, or trigger follow-up actions. The system can adaptively reallocate monitoring responsibilities in response to shifting workloads, emerging threats, or organizational changes, ensuring robust, scalable, and auditable data governance.

In additional embodiments, the architecture may be applied in precision agriculture, where fleets of autonomous ground vehicles, aerial drones, and stationary sensors collaboratively monitor and manage large farming areas. Each agent may be tasked with monitoring specific crops, applying fertilizers or pesticides, or responding to detected conditions such as drought, disease, or pest infestations. The leader agent or control system may issue commands based on satellite imagery, weather forecasts, or sensor fusion, and each agent uses process 700 to ensure it operates within its assigned area, adapts to changing environmental conditions, and coordinates with other agents to optimize yield and resource use.

Other contemplated applications include traffic management systems with autonomous vehicles or smart traffic lights acting as agents, security patrols in airports or public spaces, and coordinated response systems for disaster relief or search-and-rescue operations. In each case, the process 700 enables robust, scalable, and constraint-aware operation of distributed agents, supporting both centralized and decentralized control, dynamic adaptation to changing objectives or environments, and seamless integration with human operators or supervisory systems.

### Example Experiments and Validations

In the following sections, descriptions of the inventors' research, experiments, and validation efforts are included. However, it should be noted that the specific functions, use cases, test data sets, example environments, etc. described below are not limiting of the overall scope of the present disclosure (though these experiments do support that the various systems and methods herein represent a significant improvement in the technology/field of zone-preserving multi-agent control.

The inventors' research and validation work addressed the zone allocation and preservation problem in a leader-following setting, where a bounded time-varying command having a bounded time rate of change is available to the leader agent(s). Specifically, each agent needs to stay at their user-defined heterogeneous zones at all times. As opposed to prior attempts at control for multi-agent systems, these zones do not have to contain the origin. Furthermore, a zone of an agent can be intersecting with or disjoint from a zone of any other agent. To this end, a new state transformation method predicated on a monotonically increasing aligned diffeomorphic (mia-diffeomorphic) map is disclosed to make the solution to this problem feasible.

Building upon the transformed multiagent system, a new distributed adaptive control protocol was developed by the inventors. In particular, the inventors have established that this protocol ensures that an agent approaches a command available to the leader agent(s) when this command enters its zone and otherwise the same agent maintains proximity to this command while preserving its own zone. Here, the adaptive feature of this protocol facilitates operation without the knowledge of an upper bound for the time rate of change of the command. In addition to the presented system-theoretical results, two illustrative numerical examples are also given to demonstrate the efficacy of the overall architecture.

Notation. In the present disclosure, the sets of real numbers, positive real numbers, and nonnegative real numbers are respectively denoted as [symbol] , [symbol] , and [symbol] ; the sets of n×m real matrices, n×n positive-definite real matrices, and n×n nonnegative-definite real matrices are respectively denoted as [symbol] , [symbol] , and [symbol] ; and vector of all zeros and all ones are respectively denoted as 0ₙ and 1ₙ. Furthermore, (⋅)^{t} is used for transpose, (⋅)⁻¹ for inverse, |⋅| for absolute value, ∥⋅∥¹ for 1-norm, ∥⋅∥₂ for 2-norm, and “≡” for equality by definition. For a vector a=[a₁, a₂, . . . , aₙ]^{t}, Sgn(a)≡[sgn(a₁), . . . , sgn(aₙ)]^{t} and Tanh(a)≡[tanh(a₁), . . . , tanh(aₙ)]^{t}, where sgn(⋅) and tanh(⋅) respectively denote signum and tangent hyperbolic functions.

The graph-theoretical notation utilized in the present disclosure is now introduced. Specifically, an undirected graph is represented by [symbol] , which is characterized by the node set [symbol] ={1, . . . , n} and the edge set [symbol] with an edge (i,j)∈ [symbol] indicating that nodes i and j are neighbors (i˜j signifies neighboring relation herein). A graph [symbol] is also considered connected when a finite path i₀ i₁ . . . i_{L} exists with iₖ₋₁˜iₖ and k=1, . . . , L between any two distinct nodes. Furthermore, the degree matrix for G is defined as [symbol] ≙diag (d), where d=[d₁, . . . , dₙ]^{T} and dᵢ being the number of the neighbors of node i. The adjacency matrix for [symbol] is also defined as [symbol] , where [ [symbol] ]ᵢⱼ=1 when (i,j)∈ [symbol] and [ [symbol] ]ᵢⱼ=0 otherwise. The Laplacian matrix for [symbol] is now defined as [symbol] . Finally, let [symbol] =diag(k), k=[k₁, . . . , kₙ]^{T}, kᵢ∈ [symbol] , and assume that at least one kᵢ is nonzero. Then, [symbol] + [symbol] holds for a fixed, connected, and undirected [symbol] , where a [symbol] is considered in the present disclosure.

Diffeomorphism. A diffeomorphic map φ(x) is an isomorphic relationship between smooth manifolds, where its definition is now given.

Definition 1. For purposes of this discussion of the inventors' experiments and validation studies, a map q: S→T between two differentiable manifolds S and T is called a diffeomorphic map if it is a bijection and both φ(x) and its inverse φ⁻¹: T→S are continuously differentiable.

Some examples of diffeomorphic maps include ϕ(x)=3x+2 with [symbol] =(0,1) and [symbol] =(2,5), ϕ(x)=atanh(x) with [symbol] =(−1,1) and [symbol] , and rotation of the plane with [symbol] and [symbol] . Yet, a new and modified diffeomorphic map ϕ(x) is contemplated herein, for the use in the systems and methods of this disclosure. For this purpose, let xᵢ∈ [symbol] be the state of an agent i, where [symbol] =(xⱼ, z̅ᵢ)⊂ [symbol] such that xᵢ<x̅ᵢ. Let also [symbol] for all agents. The following definition can be provided:

Definition 2. For purposes of this discussion of the inventors' experiments and validation studies, a map φi: Si→ [symbol] between two differentiable manifolds Si and [symbol] is called a monotonically increasing aligned diffeomorphic (mia-diffeomorphic) map if it satisfies the following conditions:
i) ϕᵢ(xᵢ) is a diffeomorphic map;
ii) ϕᵢ(xᵢ) is monotonically increasing subject limₓ_{_{i→}}ₓ_{ᵢ}ϕᵢ(xᵢ)=−∞, limₓ_{ᵢ}_{→x̅}_{ᵢ}ϕᵢ(xᵢ)=∞,

$${lim}_{{x}_{i} \to {\underline{x}}_{i}} {ϕ}_{i}^{′} ( {x}_{i} ) = ∞ , and {lim}_{{x}_{i} \to {\overline{x}}_{i}} {ϕ}_{i}^{′} ( {x}_{i} ) = ∞ ,$$

where

$${ϕ}_{i}^{′} {=}^{Δ} \frac{d {ϕ}_{i}}{{dx}_{i}}$$

iii) ϕᵢ (xᵢ)=xᵢ over xᵢ ∈

[symbol]

The last item in Definition 2 means that φᵢ(xi) aligns with the identity line (i.e., the line having a unity slope and no bias) over xi∈Ui. One can readily obtain a mia-diffeomorphic map by constructing a composite function, which is discussed in the next remark.

Remark 1. For a given [symbol] =(xⱼ, x̅ᵢ), let [symbol] =(xᵢ+δᵢ, x̅ᵢ−δᵢ) with δᵢ∈(0,(x̅ᵢ−xⱼ)/2). One can then obtain a miadiffeomorphic map ϕᵢ: [symbol] using a line and an inverse hyperbolic tangent through the composite function:

$${ϕ}_{i} ( {x}_{i} ) = \{ \begin{matrix}{f}_{i} ( {x}_{i} ) , & {x}_{i} ∈ ( {\underline{x}}_{i} , {\underline{x}}_{i} + {δ}_{i} / {κ}_{i} ) ⋃ ( {\overline{x}}_{i} - {δ}_{i} / {κ}_{i} , {\overline{x}}_{i} ) , \\ {x}_{i} , & {x}_{i} ∈ {𝒰}_{i} \\ {g}_{1 i} ( {x}_{i} ) , & {x}_{i} ∈ [ {\underline{x}}_{i} + {δ}_{i} / {κ}_{i} , {\underline{x}}_{i} + {δ}_{i} ] , \\ {g}_{2 i} ( {x}_{i} ) , & {x}_{i} ∈ [ {\overline{x}}_{i} - {δ}_{i} , {\overline{x}}_{i} - {δ}_{i} / {κ}_{i} ] ,\end{matrix} \qquad Equation ( 1 )$$

where

$${f}_{i} ( {x}_{i} ) {=}^{Δ} {ξ}_{1 i}^{- 1} atanh ( {ξ}_{1 i} ( {x}_{i} - {ξ}_{2 i} ) ) + {ξ}_{2 i} , {ξ}_{1 i} = 2 / ( {\overline{x}}_{i} - {\underline{x}}_{i} ) , {ξ}_{2 i} = ( {\overline{x}}_{i} + {\underline{x}}_{i} ) / 2 , {g}_{1 i} {=}^{Δ} {m}_{0 i} + {m}_{1 i} {x}_{i} + {m}_{2 i} {x}_{i}^{2} + {m}_{3 i} {x}_{i}^{3} , {g}_{2 i} {=}^{Δ} {m}_{4 i} + {m}_{5 i} {x}_{i} + {m}_{6 i} {x}_{i}^{2} + {m}_{7 i} {x}_{i}^{3} ,$$

and κᵢ>1. In (1), g₁ᵢ(xi) and g₂ᵢ (xᵢ) are active over the transition area, where mₗᵢ∈ [symbol] , l=0, . . . , 7, are determined through solving the boundary expressions given by

$${g}_{1 i} ( {\overline{x}}_{i} + {δ}_{i} / {κ}_{i} ) = {f}_{i} ( {\underline{x}}_{i} + {δ}_{i} / {κ}_{i} ) , {g}_{1 i}^{′} ( {\underline{x}}_{i} + {δ}_{i} / {κ}_{i} ) = {f}_{i}^{′} ( {\underline{x}}_{i} + {δ}_{i} / {κ}_{i} ) , {g}_{1 i} ( {\underline{x}}_{i} + {δ}_{i} ) = x + {δ}_{i} , {g}_{1 i}^{′} ( {\underline{x}}_{i} + {δ}_{i} ) = 1 , {g}_{2 i} ( {\overline{x}}_{i} - {δ}_{i} ) = {\overline{x}}_{i} - {δ}_{i} , {g}_{2 i}^{′} ( {\overline{x}}_{i} - {δ}_{i} ) = 1 , {g}_{2 i} ( {\overline{x}}_{i} - {δ}_{i} / {κ}_{i} ) = {f}_{i} ( {\overline{x}}_{i} - {δ}_{i} / {κ}_{i} ) , and {g}_{2 i}^{′} ( {\overline{x}}_{i} - {δ}_{i} / {κ}_{i} ) = {f}_{i}^{′} ( {\overline{x}}_{i} - {δ}_{i} / {κ}_{i} ) with {g}_{1 i}^{′} {=}^{Δ} {dg}_{1 i} / {dx}_{i} , {g}_{2 i}^{′} {=}^{Δ} {dg}_{2 i} / {dx}_{i} , and {f}_{i}^{′} {=}^{Δ} {df}_{i} / {dx}_{i} .$$

Note that these expressions make ϕᵢ(xᵢ) continuous and continuously differentiable.

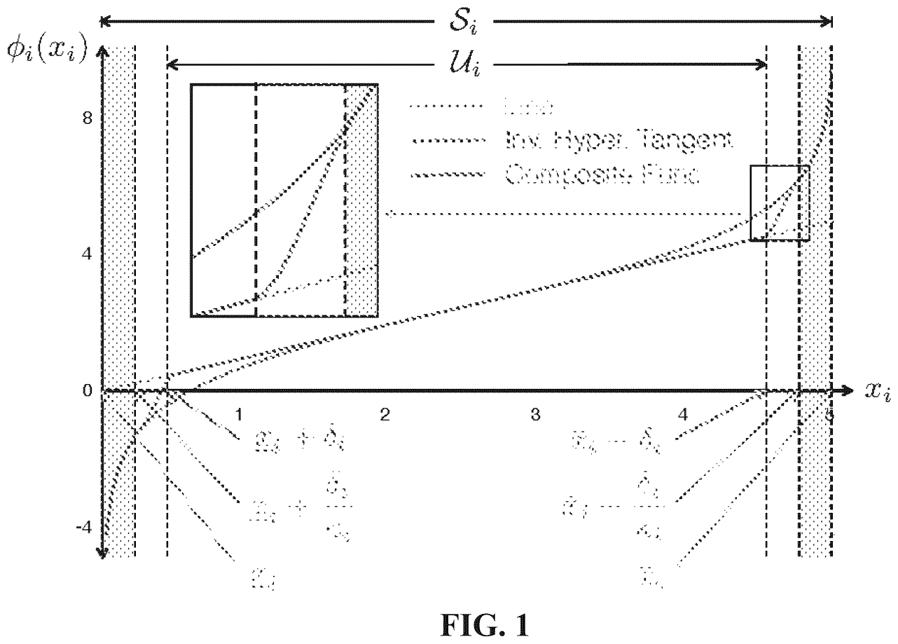

Referring now to FIG. 1, a conceptual illustration of a mia-diffeomorphic map having the above-described attributes is shown. The mia-diffeomorphic map is constructed as a composite function using a line and an inverse hyperbolic tangent, where the highlighted region in the conceptual graph denotes the transition area (l_i=0, u_i=5, βi=0.5, and αi=2). It should be noted that, given the results documented below, such a map which is predicated on Definition 2, may facilitate the extension of the methodologies in prior control attempts to address the zone allocation and preservation problems described above, and in the following section.

Problem Definition. The inventors' work initially addressed multiagent system with n agents that exchange information over a fixed, connected, and undirected graph g. A subset of these agents referred to as leader agents has access to a bounded time-varying command c(t) having a bounded time rate of change, whereas those without access are referred to as follower agents. Mathematically speaking, the single-integrator dynamics of agent i, i=1, . . . , n, has the form given by

$${\dot{x}}_{i} ( t ) = {u}_{i} ( t ) , {x}_{i} ( 0 ) = {x}_{i 0} \qquad Equation ( 2 )$$

where xi (t) and ui (t) respectively represent the state and control signal of this agent. At this point, the following is provided as the zone allocation and preservation problem.

Definition 3. Given a user-defined heterogeneous zone [symbol] =(xᵢ, x̅ᵢ)⊆ [symbol] xᵢ<x̅ᵢ, for agent i, i=1, . . . , n, the zone allocation and preservation problem is to determine uᵢ(t)∈ [symbol] such that the following conditions hold:
i)

$${}_{t \to ∞} ( {x}_{i} ( t ) - c ( t ) ) = 0$$

when c(t)∈ [symbol]
ii) ii) xᵢ(t)∈ [symbol] when c(t)∈ [symbol] or c(t)∉ [symbol] , where [symbol] is a disjoint set and the state xᵢ(t) belongs to either the left side or the right side of this set whichever is closer to the command c(t).

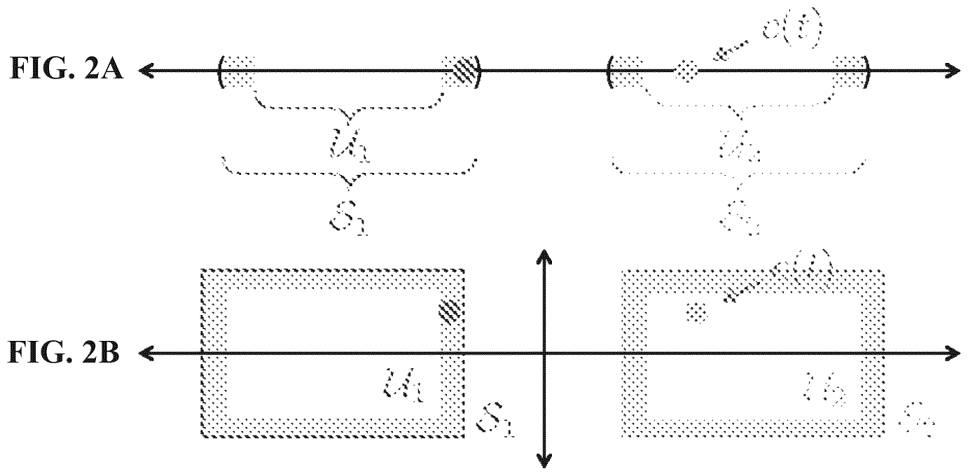

Remark 2. Definition 3 implies that the state of each agent remains within its user-defined heterogeneous zone at all times. It also implies that the state of an agent does not move to an arbitrary point within its zone. Instead, it either approaches the command when c(t)∈Ui and otherwise it maintains proximity to the command (see FIG. 2a), where “proximity” here is explicitly defined by the second item in Definition 3.

Remark 3. While the inventors consider a one-dimensional setting for the system-theoretical results presented in the present disclosure, they can be applied to multiple dimensions for agent dynamics having the form

$${\dot{x}}_{i}^{j} ( t ) = {u}_{i}^{j} ( t )$$

with j being the dimension index. Two illustrative numerical examples are described below in a two-dimensional setting (see also FIG. 2b on an interpretation of Definition 3 in such a setting).

For the solvability of the problem defined in Definition 3, the following assumption is taken:

Assumption 1. Initial conditions of the states of all agents satisfy xᵢ₀∈ [symbol] .

As the zone allocation and preservation problem is defined, the rest of this section first focuses on a new state transformation method and then presents a new disclosed distributed adaptive control protocol.

State Transformation. A state transformation is introduced to convert the constrained state xᵢ(t)∈ [symbol] to an unconstrained counterpart zᵢ(t)∈ [symbol] . For this purpose, consider a mia-diffeomorphic map ϕᵢ: [symbol] given in Definition 2. Consider also zᵢ(t)≙ϕᵢ(xᵢ(t)) that yields

$${\dot{z}}_{i} ( t ) = ( \frac{\partial {ϕ}_{i} ( {x}_{i} ( t ) )}{\partial {x}_{i} ( t )} ) {u}_{i} ( t ) \qquad Equation ( 3 )$$

for each agent. Next, let the control signal be

$${u}_{i} ( t ) = {( \frac{\partial {ϕ}_{i} ( {x}_{i} ( t ) )}{\partial {x}_{i} ( t )} )}^{- 1} {v}_{i} ( t ) \qquad Equation ( 4 )$$

with vᵢ(t)∈ [symbol] being the virtual control signal, which yields

$${\dot{z}}_{i} ( t ) = {v}_{i} ( t ) , {z}_{i} ( 0 ) = {ϕ}_{i} ( {x}_{i} ( 0 ) ) \qquad Equation ( 5 )$$

Remark 4. The above state transformation and control signal selection yield to the following observations:
i) (5) represents an unconstrained single-integrator dynamics of agent i, i=1, . . . , n.
ii) From Definition 2, the term (∂ϕᵢ(xᵢ(t))/∂xᵢ(t))⁻¹ in (4) vanishes at the boundary ∂Si of the known, bounded heterogeneous zones for each agent. Hence, if vᵢ(t) is bounded, then

$${lim}_{{x}_{i} ( t ) \to \partial {𝒮}_{i}} {u}_{i} ( t ) = 0 .$$

iii) From Definition 2, zᵢ(t)=xᵢ(t) over xᵢ(t)∈ [symbol] .

The second and third observations in Remark 4 play a key role in addressing the problem in Definition 3, where reference is made to Theorem 2 on this point.

Distributed Adaptive Control Protocol. The disclosed distributed adaptive control protocol is introduced as follows. For this purpose, consider the virtual control signal of agent i, i=1, . . . , n, given by

$${v}_{i} ( t ) = - {α}_{i} ( {\sum }_{i ∼ j} ( {z}_{i} ( t ) - {z}_{j} ( t ) ) + {k}_{i} ( {z}_{i} ( t ) - c ( t ) ) ) \qquad Equation ( 6 )$$

$$- {\hat{β}}_{i} ( {\sum }_{i ∼ j} ( {z}_{i} ( t ) - {z}_{j} ( t ) ) + {k}_{i} ( {z}_{i} ( t ) - c ( t ) ) )$$

where ai∈ [symbol] and Si (t) is the adaptive term updated according to

$${\dot{\hat{β}}}_{i} ( t ) = {γ}_{i} \vert {\sum }_{i ∼ j} ( {z}_{i} ( t ) - {z}_{j} ( t ) ) + {k}_{i} ( {z}_{i} ( t ) - c ( t ) ) \vert \qquad Equation ( 7 )$$

with γᵢ∈ [symbol] . In (6) and (7), kᵢ=1 for leader agents and otherwise kᵢ=0.

Remark one replaces Si(t) with a constant, then that constant must be chosen to be equal to or larger than an upper bound for the time rate of change of the command. Hence, the purpose of the adaptive term (7) is to enable the operation of the disclosed protocol without prior knowledge of such an upper bound.

To address the problem in Definition 3, the next section shows that the error signals

$${e}_{i} ( t ) = {z}_{i} ( t ) - c ( t ) \qquad Equation ( 8 )$$

of each agent asymptotically approach zero in the unconstrained domain. For the actual constrained domain involving the heterogeneous zones of each agent, it corresponds to an agent approaching a command when this command enters its zone and otherwise the same agent maintains proximity to this command while preserving its zone.

System-Theoretical Analysis. The system-theoretical analysis of the disclosed architecture is now presented. To this end, by adding and subtracting c(t) in (6), and using (5), the time derivative of this error ei(t) yields

$${e}_{i} ( t ) = - {α}_{i} ( {\sum }_{i ∼ j} ( {e}_{i} ( t ) - {e}_{j} ( t ) ) + {k}_{i} {e}_{i} ( t ) ) - {\hat{β}}_{i} ( t ) sgn ( {\sum }_{i ∼ j} ( {e}_{i} ( t ) - {e}_{j} ( t ) ) + {k}_{i} {e}_{i} ( t ) ) {e}_{i} ( 0 ) = {e}_{i 0} - \dot{c} ( t ) \qquad Equation ( 9 )$$

Next, let

$$e ( t ) {=}^{Δ} {[ {e}_{1} ( t ) , … , {e}_{n} ( t ) ]}^{T} , 𝒜 = diag ( {[ {α}_{1} , … , {α}_{n} ]}^{T} ) , \hat{ℬ} ( t ) = diag ( {[ {\hat{β}}_{1} ( t ) , … , {\hat{β}}_{n} ( t ) ]}^{T} ) , ℱ ( 𝒢 ) {=}^{Δ} ℒ ( 𝒢 ) + 𝒦 ∈ {ℝ}_{+}^{n \times n}$$

with [symbol] being the Laplacian matrix for a fixed, connected, and undirected graph [symbol] , and [symbol] =diag(k) with k=[k₁, . . . , kₙ]^{T}. The compact form of (9) can then be wri en as

$$\dot{e} ( t ) = - 𝒜ℱ e ( t ) - \hat{ℬ} ( t ) Sgn ( ℱ e ( t ) ) - {1}_{n} \dot{c} ( t ) \# \qquad Equation ( 10 )$$

The following two theorems aid in setting forth several of the advantages of the present disclosure.

Theorem 1. Consider the transformed multiagent system consisting of n agents over a fixed, connected, and undirected graph g with dynamics given by (5) subject to Assumption 1. Then, the virtual control signals given by (6) and (7) yield

$${lim}_{t \to ∞} {e}_{i} ( t ) = 0$$

for all agents.

### Proof Consider the Energy Function

$$𝒱 ( \cdot ) = \frac{1}{2} {e}^{T} ℱ e + \frac{1}{2 {γ}_{i}} {\sum }_{i = 1}^{n} {\tilde{β}}_{i}^{2} \qquad Equation ( 11 )$$

\tilde{β}ᵢ(t)=\hat{β}ᵢ(t)−ċ̅ with ċ̅ being the upper bound of the time derivative of the command c(t). The time-derivative of (11) satisfies

$$\dot{𝒱} ( \cdot ) = - {e}^{T} ( t ) ℱ𝒜ℱ e ( t ) - {e}^{T} ( t ) ℱ \hat{ℬ} ( t ) Sgn ( ℱ e ( t ) ) - {e}^{T} ( t ) {ℱ1}_{n} \dot{c} ( t ) + \frac{1}{{γ}_{i}} {\sum }_{i = 1}^{n} {\tilde{β}}_{i} ( t ) {\dot{\tilde{β}}}_{i} ( t ) \qquad Equation ( 12 )$$

Note that −e^{T}(t) [symbol] (t)Sgn( [symbol] (t)) in (12) can be written in the form given by

$$- {e}^{T} ( t ) ℱ \hat{ℬ} ( t ) Sgn ( ℱ e ( t ) ) = - {\sum }_{i = 1}^{n} {\hat{β}}_{i} ( t ) \vert {\sum }_{i ∼ j} ( {e}_{i} ( t ) - {e}_{j} ( t ) ) + {k}_{i} {e}_{i} ( t ) \vert \qquad Equation ( 13 )$$

and −e^{T}(t) [symbol] 1ⁿc(t) in (12) can be upper bounded as

$$- {e}^{T} ( t ) {ℱ1}_{n} \dot{c} ( t ) = {\sum }_{i = 1}^{n} \vert {\sum }_{i ∼ j} ( {e}_{i} ( t ) - {e}_{j} ( t ) ) + {k}_{i} {e}_{i} ( t ) \vert \dot{\overline{c}} \leq {\vert {e}^{T} ( t ) ℱ \vert}_{1} \dot{\overline{c}} \qquad Equation ( 14 )$$

Using (13) and (14) in (12) and \tilde{\dot{β}}₁(t)=\hat{\dot{β}}ᵢ(t), one can obtain

$$\dot{𝒱} ( \cdot ) \leq - {e}^{T} ( t ) ℱ𝒜ℱ e ( t ) - {\sum }_{i = 1}^{n} {\hat{β}}_{i} ( t ) \vert {\sum }_{i ∼ j} ( {e}_{i} ( t ) - {e}_{j} ( t ) ) + {k}_{i} {e}_{i} ( t ) \vert + {\sum }_{i = 1}^{n} \vert {\sum }_{i ∼ j} ( {e}_{i} ( t ) - {e}_{j} ( t ) ) + {k}_{i} {e}_{i} ( t ) \vert \dot{\overline{c}} + \frac{1}{{γ}_{i}} {\sum }_{i = 1}^{n} {\tilde{β}}_{i} ( t ) {\hat{β}}_{i} ( t ) \leq - {e}^{T} ( t ) ℱ𝒜ℱ e ( t ) - ( {\sum }_{i = 1}^{n} {\tilde{β}}_{i} ( t ) ) \vert {\sum }_{i ∼ j} ( {e}_{i} ( t ) - {e}_{j} ( t ) ) + + {k}_{i} {e}_{i} ( t ) \vert + \frac{1}{{γ}_{i}} {\sum }_{i = 1}^{n} {\tilde{β}}_{i} ( t ) {\hat{β}}_{i} ( t ) \qquad Equation ( 15 )$$

Adding and subtracting c(t) to (7), using the resulting expression in (15), and since

$$ℱ𝒜ℱ ∈ {ℝ}_{+}^{n \times n} ,$$

it is concluded that

$$\dot{𝒱} ( \cdot ) \leq - {e}^{T} ( t ) ℱ𝒜ℱ e ( t ) \leq 0 \qquad Equation ( 16 )$$

Hence, the pair (eᵢ(t), \tilde{β}ᵢ(t)) is bounded for all agents. It can now be concluded that the right-hand side of (16) approaches zero asymptotically, where this implies that

$${lim}_{t \to ∞} {e}_{i} ( t ) = 0$$

for all agents. ▪

Note that the above theorem extends beyond the scope of problem addressed in the present disclosure, which offers applicability to unconstrained distributed control problems within a leader-follower framework. Building upon the results of Theorem 1, the next theorem shows that the disclosed overall architecture solves the problem in Definition 3.

Theorem 2. Consider a multiagent system consisting of n agents over a fixed, connected, and undirected graph g with dynamics given by (2) subject to Assumption 1. Then, the disclosed overall architecture given by (4), (6), and (7) solves the problem in Definition 3.

Proof Over the unconstrained domain zᵢ(t)∈ [symbol] represented by (5), it is proven in Theorem 1 that each agent asymptotically follows the command c(t). Over the constrained domain xᵢ(t)∈ [symbol] represented by (2), it is shown:
i) If c(t)∈ [symbol] for agent i, then

$${lim}_{t \to ∞} ( {x}_{i} ( t ) - c ( t ) ) = 0 since {lim}_{t \to ∞} {e}_{i} ( t ) = 0$$

Theorem 1 and zᵢ(t)=xᵢ(t) over xᵢ(t)∈ [symbol] by Definition 2.
ii) If c(t)∈ [symbol] or c(t)∉ [symbol] for agent i, then xi(t)∈ [symbol] .

The former case, when c(t)∈ [symbol] , holds since the state xi (t) of this agent must enter [symbol] owing to the fact that the term (∂ϕᵢ(xᵢ(t))/∂xᵢ(t))⁻¹ in its control signal (4) is unity at the boundary ∂Ui. The latter case, when c(t)∈ [symbol] , also holds since its virtual control signal (6) is bounded by Theorem 1 and the term (∂ϕᵢ(xᵢ(t))/∂xᵢ(t))⁻¹ in its control signal (4) vanishes at the boundary ∂Si of its zone by Definition 2, which together yields

$${lim}_{{x}_{i} ( t ) \to \partial {𝒮}_{i}} {u}_{i} ( t ) = 0$$

(i.e., the state xi(t) of this agent cannot leave [symbol] ). Finally, since [symbol] is a disjoint set, this further implies for the latter case that the state xi (t) of this agent practically stops moving at either the left side or the right side of this set, whichever is closer to the command c(t) (i.e., xi (t) maintains proximity to c(t) when c(t)∈ [symbol] ).

This shows that the disclosed overall architecture given by (4), (6), and (7) solves the problem in Definition 3. ▪

Remark 6. While the state xi (t) of agent i can follow the command c(t) to some extent when c(t)∈Sdi and c(t) stays close to the boundary ∂Ui, this may not hold when c(t)∈ [symbol] and c(t) stays close to the boundary ∂Si. This issue can practically be addressed through enlarging the domain Ui (e.g., through decreasing [symbol] in Remark 1).

Illustrative Numerical Examples. Two illustrative numerical examples are provided to demonstrate the efficacy of the overall architecture. Before presenting these examples, the following remark is stated:

Remark 7. Two observations are highlighted that need to be considered in the practical applications of the disclosed architecture. First, it is common practice to approximate sgn(x) in (6) with tanh(px) with p∈ [symbol] being a large constant to avoid the chattering phenomenon in the control signals of each agent. Second, the adaptive term of each agent given by (7) can take large numbers since its righthand side is always a nonnegative quantity. To mitigate this situation, a leakage term can be introduced as follows

$${\dot{\hat{β}}}_{i} ( t ) = {γ}_{i} \vert {\sum }_{i ∼ j} ( {z}_{i} ( t ) - {z}_{j} ( t ) ) + {k}_{i} ( {z}_{i} ( t ) - c ( t ) ) \vert - {σ}_{i} {\hat{β}}_{i} ( t ) \qquad Equation ( 17 )$$

with σᵢ∈ [symbol] IR being sufficiently small. Despite these modifications, the efficacy of the disclosed architecture remains sufficiently close to its original one.

Two examples are now ready to be given in a two-dimensional setting. To this end, subscripts “x” and “y” are added to the related signals to clarify the distinction between the two axes. In the first example, let the first agent have access to the command given by cₓ(t)=1.75 sin(0.05t)+2 and c_{y}(t)=1.75 cos(0.05t)+2 over t∈[0,120]. Here, the user-defined zones [symbol] =[i, xₓᵢ, x̅_{yi}x_{yi}, x̅_{yi}] of each agent are chosen as [symbol] =[2,4,2,4], [symbol] =[2,4,0,2], [symbol] =[0,2,0,2], [symbol] =[0,2,2,4]. In addition, the initial [symbol] conditions (xₓᵢ(0),x_{yi}(0)) of agents are respectively chosen (3,3), (3,1), (1,1), and (1,3) to satisfy Assumption 1. The mia-diffeomorphic map given by (1) with δᵢ=0.3 and κᵢ=3 for all agents is also used. Finally, αᵢ=1 for (6), γᵢ=1 and σᵢ=0.01 for (17) in view of Remark 7, and use tanh(ρx) with ρ=50 instead of sgn(x) is used also in view of Remark 7.

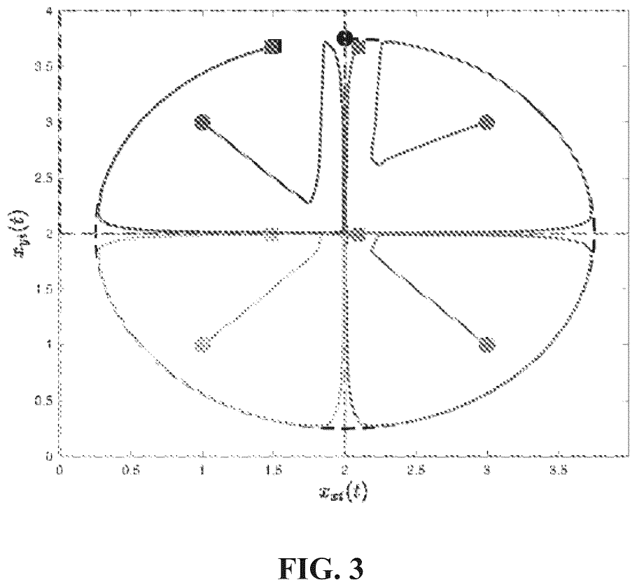

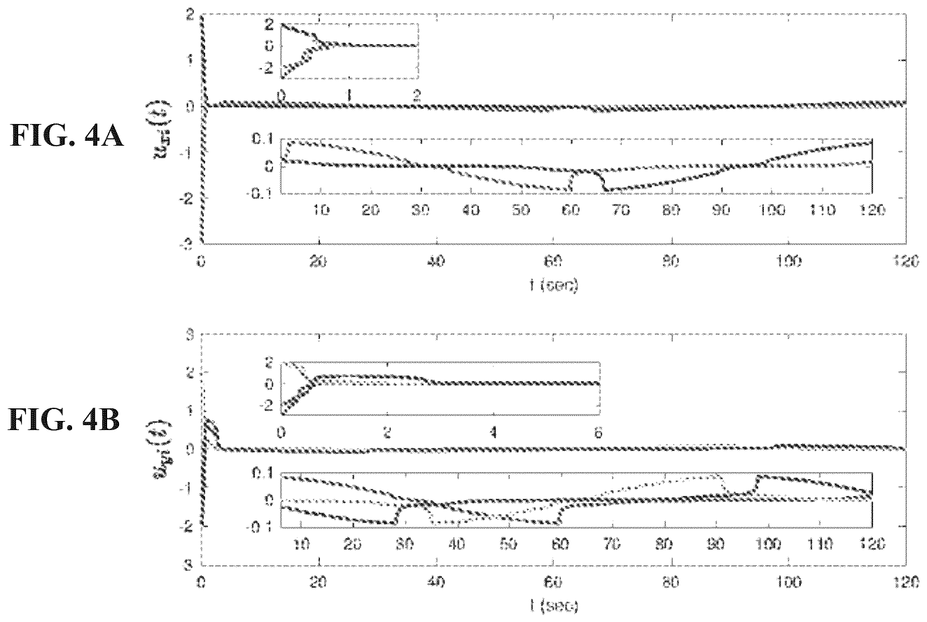

Referring now to FIG. 3, a closed-loop multiagent system response is shown, based on a system with the disclosed architecture. As shown, the different lines respectively indicate agents 1, 2, 3, and 4, and the black dashed line indicates the command. The circle and the square markers respectively represent the initial position and the final position. FIG. 4 shows the control histories of the disclosed architecture, where the top and bottom figures respectively show the control signal for each agent along the x-axis and the y-axis. Thus, from these figures, it is clear that all agents approach the command when this command is in their zones and otherwise maintain proximity to this command while preserving their zones.

In the second example, let the first agent have access to the command given by cₓ(t)=2 sin(0.05t)+2 and c_{y}(t)=t/20 over t∈[0,120]. Here, the user-defined zones [symbol] =[xₓᵢ,x̅ₓᵢ, x_{yi},x̅_{yi}] of each agent are chosen as [symbol] =[0,3,2,6], [symbol] =[0,3,0,5], [symbol] =[1,4,2,6], [symbol] =[2,4,0,5]. In addition, the initial conditions (xₓᵢ(0), x_{yi}(0)) of agents are respectively chosen (1,3), (2,1), (2.5,4), and (3,2) to satisfy Assumption 1. All the remaining parameters are chosen identical to the first example.

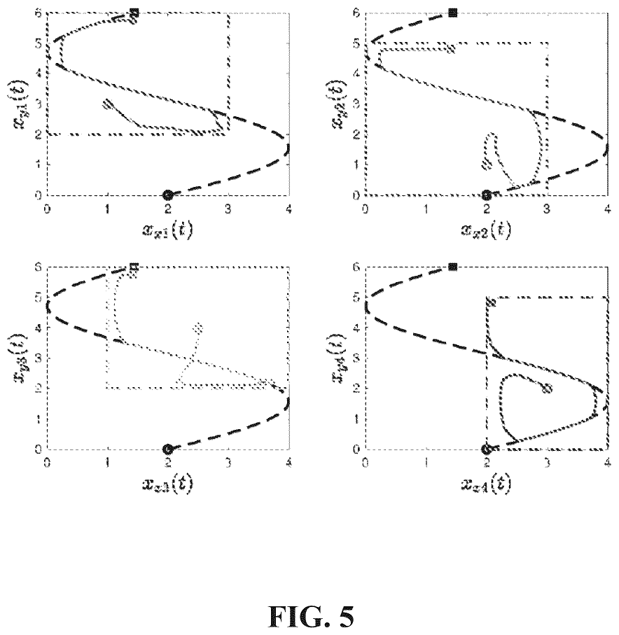

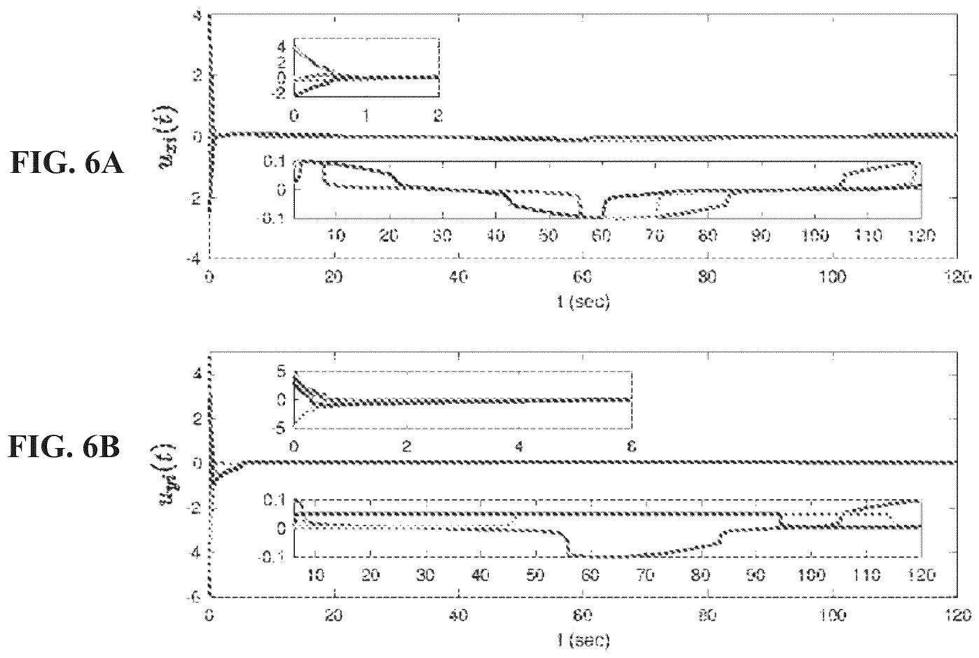

FIG. 5 shows the individual closed-loop multiagent system responses. Individual closed-loop agent responses are graphed, based on a system with the disclosed architecture, where the different lines respectively indicate agents 1, 2, 3, and 4, and the black dashed line indicates the command. The circle and the square markers respectively represent the initial position and the final position. FIG. 6 shows the corresponding control histories, based on a system having the proposed architecture, where the top and bottom figures respectively show the control signal for each agent along the x-axis and the y-axis. Once again, from these figures, it is clear that all agents approach the command when this command is in their zones and otherwise they maintain proximity to this command while preserving their zones

A solution to the zone allocation and preservation problem in multiagent systems (see Definition 3) is therefore established and confirmed as addressed herein. Predicated on a mia-diffeomorphic map (see Definition 2), a new state transformation is first used to convert the constrained states of agents, resulting from user-defined heterogeneous zones, to their unconstrained counterpart. Subsequently, a new distributed adaptive control protocol is disclosed within a leader-follower setting (though as noted above, this approach can also be used in other scenarios). Notably, it is shown in Theorems 1 and 2 that the overall architecture solves the zone allocation and preservation problem. This is achieved by ensuring an agent approaches a command available to the leader agents(s) when this command enters its zone and otherwise the same agent maintains proximity to this command while preserving its own zone. Two illustrative numerical examples are also provided to showcase the efficacy of this architecture.

### Supplemental Example—Corrective Signals

Certain benefits can be realized by using a norm-based event rule over a norm-free rule. Choosing the parameters for event rules, particular those in the map g(⋅), to achieve satisfactory close-loop performance that is close the the ideal performance is a challenge. While one can use small parameters in g(⋅) to achieve satisfactory closed-loop response with a norm-based event rule, the resulting event rules can yield to dramatically increased number of events as these parameters get smaller. On the other hand, norm-free event rules may not allow for satisfactory closed-loop performance over some time intervals regardless of the chosen parameters in g(⋅). Because, there are no events when the map f(uₛ(t)−u(t),−) is negative, and therefore, the mismatch term uₛ(t)−u(t) continues to act as a disturbance during such time intervals for norm-free event rules.

Consider the dynamical system \dot{x}(t)=uₛ(t), x(0)=−1, driven with the sampled data version of u(t)=−x(t). Consider also the norm-based event rule |uₛ(t)−u(t)|<ψ|x(t)| and the norm-free event rule x(t)(uₛ(t)−u(t))≤ψx²(t), where ψ∈[0,1). Using [symbol] (x)=0.5x², the inventors arrive at [symbol] (x)≤−2(1−ψ) [symbol] (x) for both event rules, which gives exponential stability. The performance of the norm-based event rule is shown for ψ=0.1 (dotted red line) and ψ=0.9 (dashed blue line), which respectively results in 43 and 8 events. The performance of the norm-free event rule is also shown for ψ=0.5 (solid black line), which results in 2 events (the number of events remains the same for ψ=0.1 and ψ=0.9). Hence, the norm-free event rule results in fewer events than its norm-based counterpart in this example.

### 1.2 Mathematical Preliminaries.

In this disclosure [symbol] , [symbol] and [symbol] respectively denote the sets of real numbers, n×1 real vectors, and n×m real matrices; and [symbol] , [symbol] , and

$${ℝ}_{+}^{n \times n} , and {\overline{ℝ}}_{+}^{n \times n}$$

respectively denote the sets of positive real numbers, nonnegative real numbers, positive-definite real matrices, and nonnegative definite real matrices. The inventors also use (⋅)T for transpose, (⋅)⁻¹ for inverse, ∥⋅|∥₂ for the Euclidean norm, λ(A) (respectively, λ̅(A)) for the minimum (respectively, maximum) eigenvalue of real matrix A∈ [symbol] , and “≙“ for the equality by definition.

The next two lemmas on Young's inequality and the comparison principle are needed for the main results of this disclosure.
Lemma 1. The inequality holds for x∈ [symbol] and y∈ [symbol] , where ϵ₀ ∈ [symbol] .

$${x}^{T} y \leq \frac{{ϵ}_{0}}{2} {x}^{T} x + \frac{1}{2 {ϵ}_{0}} {y}^{T} y . \qquad i$$

Lemma 2. Consider the dynamical system
   b.

$$\dot{\overline{v}} ( t ) = f ( t , \overline{v} ( t ) ) , \overline{v} ( 0 ) = {\overline{v}}_{0} ,$$

with v̅(t)∈ [symbol] and f(t, v̅(t)) being continuous in t and locally Lipschitz in v̅(t) for all t∈ [symbol] and all v̅(t)∈ [symbol] ⊂ [symbol] . Let [0, T) be the maximal interval of existence of the solution v̅(t) and suppose v̅(t)∈ [symbol] for all t∈[0, T). Furthermore, let v(t) be a continuous function satisfying
c.

$$\dot{v} ( t ) \leq f ( t , v ( t ) ) , v ( 0 ) \leq {\overline{v}}_{0} ,$$

where v(t)∈ [symbol] for all t∈[0, T). Then, the inequality v(t)≤v̅(t) holds [symbol] for all t∈[0, T), where T could be infinity.

### Problem Definition

Consider the linear time-invariant system given by
d.

$$\dot{x} ( t ) = Ax ( t ) + {Bu}_{s} ( t ) , x ( 0 ) = {x}_{0} .$$

In (4), A∈ [symbol] and B∈ [symbol] are a controllable pair, x(t)∈ [symbol] is a measurable state, and uₛ(t)∈ [symbol] is the sampled data version of a continuous control signal
e.

$$u ( t ) = - {K}_{1} x ( t ) + {K}_{2} c ( t ) + δ ( t ) ,$$

where K₁∈ [symbol] and K₂∈ [symbol] are respectively feedback and feedforward gain matrices with A−BK₁ being Hurwitz, c(t)∈ [symbol] is a bounded time-varying command with bounded time rate of change, and δ(t)∈ [symbol] is the disclosed corrective signal (details in the next paragraph). Note that the form of the continuous control signal given by (5) is chosen as a pedagogical example and does not limit the general applicability of the results presented in this disclosure as the findings can be extended to other control laws with only minor modifications.

Adding and subtracting the term Bu(t) to (4), and then using (5), one can obtain the closed-loop system as
f.

$$\dot{x} ( t ) = {A}_{r} x ( t ) + {B}_{r} c ( t ) + B ( δ ( t ) + ( {u}_{s} ( t ) - u ( t ) ) ) ,$$

where Aᵣ ≙A−BK₁ and Bᵣ≙BK₂. The aim of introducing the corrective signal d(t) is to suppress the effect of the mismatch term uₛ(t)−u(t) so that the resulting closed-loop system performance approaches its ideal (i.e., non-event-triggered) one (i.e., (6) without the term δ(t)+(uₛ(t)−u(t))). To achieve this goal, the inventors design the corrective signal as
g.

$$\dot{δ} ( t ) {=}^{Δ} - μ ( δ ( t ) + ( {u}_{s} ( t ) - u ( t ) ) ) , δ ( 0 ) = 0 ,$$

where μ∈ [symbol] is the gain of the corrective signal. Observe that the inventors select the initial condition as zero since it is a reasonable choice given that uₛ(0)=u(0).

Remark 1. Observing the error \tilde{δ}(t)≙δ(t)+(uₛ(t)−u(t)) in (6), which is desired to be suppressed, one may intend to trivially select the corrective signal as δ(t)=−(uₛ(t)−u(t)) rather than selecting it. However, this trivial selection yields to an algebraic loop when it is inserted to (5), which makes it impossible to define a valid continuous control signal. For the wellposedness of this signal, the inventors design the corrective signal according to (7), which approximates its above trivial selection without an algebraic loop as the gain μ of this corrective signal is increased.

To introduce the event rule for scheduling state feedback control data transmissions, let

$$e ( t ) {=}^{Δ} x ( t ) + {A}_{r}^{- 1} {B}_{r} c ( t )$$

be the error signal. Using the closed-loop system, one can obtain the time derivative of this error signal as

$$\dot{e} ( t ) = {A}_{r} e ( t ) + B ( δ ( t ) + ( {u}_{s} ( t ) - u ( t ) ) ) , + {A}_{r}^{- 1} {B}_{r} \dot{c} ( t ) , e ( 0 ) = {e}_{0} .$$

Next, consider the norm-free event rule given by

$$2 {e}^{T} ( t ) PB ( {u}_{s} ( t ) - u ( t ) ) - 2 {μγδ}^{T} ( t ) ( {u}_{s} ( t ) - u ( t ) ) \leq {ψ}_{1} {e}^{T} ( t ) e ( t ) + {ψ}_{2} {δ}^{T} ( t ) δ ( t ) + {ψ}_{3} ( t ) ,$$

where P∈

$${ℝ}_{+}^{n \times n}$$

is the solution to the Lyapunov equation

$$0 = {A}_{r}^{T} P + {PA}_{r} + I ,$$

γ∈ [symbol] , ψ₁∈ [symbol] , ψ₂∈ [symbol] , and ψ₃(t)∈ [symbol] is a bounded function of time. In addition, consider that the following assumption holds.

Assumption 1. The matrix given by

$$𝒩 {=}^{Δ} [ \begin{matrix}( 1 - {ψ}_{1} ) I & - PB \\ - {B}^{T} P & ( 2 μγ - {ψ}_{2} ) I\end{matrix} ]$$

is positive-definite.

Thus, a problem definition for state feedback event-triggered control: Consider the system (4) with the control law (5) involving the disclosed corrective signal (7). Consider also the event rule (10) under Assumption 1. The inventors objective is to show the boundedness of the resulting closed-loop system, and its global exponential stability for the special case when the command is constant and ψ₃(t)≡0 in the norm-free event rule (10) with performance recovery.

Remark 2. The boundedness of the resulting closedloop system with constant or time-varying bias terms in event rules such as ψ₃(t) in (10) is standard. When these bias terms are zero, the inventors here guarantee global exponential stability when the command is constant. One can extend The inventors results using cooperative output regulation theory to guarantee global asymptotic or exponential stability for bounded time-varying commands as well when ψ₃(t)≡0 in (10). The inventors do not provide such an extension in this disclosure since the inventors are interested in performance recovery in event-triggered control theory.

### System-Theoretical Analyses

The next theorem presents The inventors first main result on the stability of the closed-loop system with the eventtriggered state feedback control architecture presented in Section 2.1.

Theorem 1. Consider the linear time-invariant system (4) subject to the state feedback control law (5), which involves the disclosed corrective signal (7). Consider also the norm-free event rule (10) subject to Assumption 1. Then, the pair (e(t), δ(t)) is bounded according to

$${𝒱}_{1} ( \cdot ) \leq {𝒱}_{1 , 0} exp ( - {b}_{0} t ) + {b}_{0}^{- 1} {b}_{1} ,$$

$$where$$

$${𝒱}_{1} ( e , δ ) {=}^{Δ} {e}^{T} Pe + {γδ}^{T} δ ,$$

$${𝒱}_{1 , 0} {=}^{Δ} {e}_{0}^{T} {Pe}_{0} , {b}_{0} {=}^{Δ} min \{ ( \underline{λ} ( 𝒩 ) - \frac{1}{2 ε} ) / \underline{λ} ( P ) , ( \underline{λ} ( 𝒩 ) - \frac{1}{2 ε} ) / γ \} , \\ {b}_{1} {=}^{Δ} \frac{1}{2 ε} {‖ ϱ ‖}_{2}^{2} + {\overline{ψ}}_{3} , {ψ}_{3} ( t ) \leq {\overline{ψ}}_{3} , ϱ {=}^{Δ} {[ {( 2 {PA}_{r}^{- 1} {B}_{r} \overline{\dot{c}} )}^{T} , 0 ]}^{T} , {‖ \dot{c} ( t ) ‖}_{2} \leq \overline{\dot{c}} ,$$

and ε∈ [symbol] an arbitrary constant satisfying

$$𝒩 - \frac{ε}{2} I ∈ {ℝ}_{+}^{n \times n} .$$

in addition, the command is constant and ψ₃(t)≡0 in (10), then the origin of the pair (e(t), δ(t)) is globally exponentially stable.

Proof. The time derivative of (13) satisfies

$${\dot{𝒱}}_{1} ( \cdot ) = - {e}^{T} ( t ) e ( t ) + 2 {e}^{T} ( t ) PB δ ( t ) - 2 {μγδ}^{T} ( t ) δ ( t ) + 2 {e}^{T} ( t ) PB ( {u}_{s} ( t ) - u ( t ) ) - 2 {μγδ}^{T} ( t ) ( {u}_{s} ( t ) - u ( t ) ) + 2 {e}^{T} ( t ) {PA}_{r}^{- 1} {B}_{r} \dot{c} ( t ) ,$$

and using the norm-free event rule (10) in (14) yields

$${\dot{𝒱}}_{1} ( \cdot ) \leq - ( 1 - {ψ}_{1} ) {e}^{T} ( t ) e ( t ) - ( 2 μγ - {ψ}_{2} ) {δ}^{T} ( t ) δ ( t ) + 2 {e}^{T} ( t ) PB δ ( t ) + {ψ}_{3} ( t ) + 2 {e}^{T} ( t ) {PA}_{r}^{- 1} {B}_{r} \dot{c} ( t ) \leq - {σ}^{T} ( t ) 𝒩σ ( t ) + {σ}^{T} ( t ) ϱ + {\overline{ψ}}_{3}$$

with σ(t)≙[e^{T}(t), δ^{T}(t)]^{T}. Now, using Lemma 1 on the second term in (15) results in

$${\dot{𝒱}}_{1} ( \cdot ) \leq - {σ}^{T} ( t ) ( 𝒩 - \frac{1}{2 ε} I ) σ ( t ) + \frac{ε}{2} {ϱ}^{T} ϱ + {\overline{ψ}}_{3} \leq - \frac{( \underline{λ} ( 𝒩 ) - \frac{1}{2 ε} )}{\underline{λ} ( P )} {e}^{T} ( t ) Pe ( t ) + \frac{ε}{2} {ϱ}^{T} ϱ - \frac{( \underline{λ} ( 𝒩 ) - \frac{1}{2 ε} )}{γ} {γδ}^{T} ( t ) δ ( t ) + {\overline{ψ}}_{3} \leq - {b}_{0} {𝒱}_{1} ( \cdot ) + {b}_{1} .$$

From Lemma 2, it now follows that the pair (e(t), δ(t)) is bounded according to (12). Finally, if the command is constant and ψ₃(t)≡0, then b₁≡0 in (16). In this case, (12) reduces to [symbol] (⋅)≤ [symbol] exp(−b₀t), which gives global exponential stability of the origin of (e(t), δ(t)).

Remark 3. Note that (12) in Theorem 1 implies that \dot{x}(t) is bounded from (4) and \dot{δ}(t) is bounded from (7).

Thus, there is α∈ [symbol] such that

$$\frac{d}{dt} {‖ {u}_{s} ( t ) - u ( t ) ‖}_{2} \leq {‖ \frac{d}{dt} {u}_{s} ( t ) - \frac{d}{dt} u ( t ) ‖}_{2} = {‖ - {K}_{1} \dot{x} ( t ) + {K}_{2} \dot{c} ( t ) + \dot{δ} ( t ) ‖}_{2} \leq α$$

a holds over t∈(tᵢ, tᵢ₊₁). Using this and

$${lim}_{t \to {t}_{i}^{+}} {‖ {u}_{s} ( t ) - u ( t ) ‖}_{2} = 0 ,$$

the inventors arrive

$${‖ {u}_{s} ( t ) - u ( t ) ‖}_{2} \leq α ( t - {t}_{i} )$$

over t∈(tᵢ, tᵢ₊₁). In (10), now let ψ₃(t)≅0 over t∈[0, ∞). Observe that the left side of (10) (i.e., (2e^{T}(t)PB−2μγδ^{T} (t))(uₛ(t)−u(t))(uₛ(t)−u(t))) needs to be positive for an event to occur (i.e., the product of (2e^{T}(t)PB−2μγδ^{T}(t))≠0 and (uₛ(t)−u(t))≠0 needs to be positive), which implies that there exists β∈ [symbol] such that

$${lim}_{t \to {t}_{i + 1}^{-}} {‖ {u}_{s} ( t ) - u ( t ) ‖}_{2} = β .$$

(i.e., otherwise an event cannot occur). From (17), this yields

$$β \leq α ( {t}_{i + 1} - {t}_{i} )$$

and therefore tᵢ₊₁−tᵢ is bounded away from zero. This shows that Zeno behavior cannot occur when ψ₃(t)≠0 in (10).

The next theorem presents The inventors second main result on performance recovery, which shows that the closed-loop system performance approaches to its ideal one as the gain μ of the corrective signal (7) is increased. For this result, the inventors define the ideal closed-loop system performance according to

$${\dot{x}}_{r} ( t ) = {A}_{r} {x}_{r} ( t ) + {B}_{r} c ( t ) , {x}_{r} ( 0 ) = {x}_{0} ,$$

with xᵣ(t)∈ [symbol] being the ideal state of the ideal closedloop system. The inventors are now ready to give the following result.

Theorem 2. Consider the closed-loop system given by (6) and the dynamics of the corrective signal given by (7). Consider also the norm-free event rule given by (10) subject to Assumption 1. Then, the closed-loop system performance approaches its ideal one as μ is increased.

Proof. First, all signals appearing in (6) and (7) are bounded for the norm-free event rule under Assumption 1 from Theorem 1. Next, define eᵣ(t)≙x(t)−xᵣ(t), which yields

$${\dot{e}}_{r} ( t ) = {A}_{r} {e}_{r} ( t ) + B \tilde{δ} ( t ) , {e}_{r} ( 0 ) = 0.$$

Here, eᵣ(t) is a bounded signal owing to Theorem 1 that captures the difference between the resulting closed-loop system and the ideal closed-loop system. If the inventors show that eᵣ(t) approaches to zero as μ is increased, then this yields the performance of the closed-loop system given by (6) to approach its ideal one given by (19).

Now, the dynamics of the corrective signal given by (7) can be equivalently represented in Laplace domain as [symbol] as

$$Δ s = - {𝒯}_{lp} ( s ) ( {U}_{s} ( s ) - U ( s ) ) ,$$

$$where$$

$${𝒯}_{lp} ( s ) {=}^{Δ} \frac{1}{{μ}^{- 1} s + 1}$$

is a low-pass filter with a pole strictly on the left half plane, Δ(s)≙ [symbol] {δ(t)}, Uₛ(s)≙ [symbol] {uₛ(t)}, U(s)≙ [symbol] {u(t)}, and s is the Laplace variable. The error δ(t)=δ(t)+(uₛ(t)−u(t)) in (20), which is also bounded owing to Theorem 1, can be further equivalently represented in Laplace domain as

$$\tilde{Δ} ( s ) = {𝒯}_{hp} ( s ) ( {U}_{s} ( s ) - U ( s ) ) ,$$

$$where$$

$${𝒯}_{hp} ( s ) {=}^{Δ} ( 1 - {𝒯}_{lp} ( s ) ) = \frac{{μ}^{- 1} s}{{μ}^{- 1} s + 1}$$

is a high-pass filter with a pole strictly on the left half plane and \tilde{Δ}(s)≙ [symbol] {\tilde{δ}(t)}. Since [symbol] (s) is a high-pass filter, the output \tilde{Δ}(s) of the transfer function [symbol] (s) suppresses the effect of its input Uₛ(s)−U(s) over frequencies less than the cutoff frequency of this transfer function, which is μ radians per second.

Finally, the inventors also represent (20) in Laplace domain as

$${E}_{r} ( s ) = 𝒫 ( s ) \tilde{Δ} ( s ) ,$$

$$where$$

$$𝒫 ( s ) {=}^{Δ} {( sI - {A}_{r} )}^{- 1} B$$

has n poles strictly on the left half plane (i.e., the eigenvalues of the Hurwitz matrix Aᵣ) and Eᵣ(s)≙ [symbol] {eᵣ(t)}. Observe from the strictly proper nature of [symbol] (s) [Chapter 4.3.1, 11] that the existence of a frequency ξ∈ [symbol] is guaranteed such that the output Eᵣ(s) of the transfer function [symbol] (s) suppresses the effect of its input \tilde{Δ}(s) over frequencies that are more than ξ radians per second. Using (23) in (25) now results in

$${E}_{r} ( s ) = 𝒫 ( s ) {𝒯}_{hp} ( s ) ( {U}_{s} ( s ) - U ( s ) )$$

where the transfer function [symbol] suppresses signals over frequencies that are less than μ radians per second and the transfer function [symbol] (s) suppresses signals over frequencies that are more than ξ radians per second. As a consequence, the output Eᵣ(s) of the transfer function [symbol] suppresses the effect of its input Uₛ(s)−U(s) over the entire frequency range as μ gets larger than ξ. This means that the closed-loop system performance approaches its ideal closed-loop system performance as μ is increased.

Remark 4. Theorem 2 shows performance recovery in event-triggered state feedback control with the disclosed corrective signal. On the selection of μ of this corrective signal, one can first construct a Bode plot of the transfer function [symbol] (s) in order to determine ξ mentioned in the proof of this theorem. One can then construct Bode plots of the transfer function [symbol] for a family of μ selections with μ>ξ. Without the need of making μ sufficiently large, one can finally look at these Bode plots and judiciously choose μ. For example, if one wants to reduce the effect of the input Uₛ(s)−U(s) that appears at the output Eᵣ(s) of (27) by κ∈(0,1) times, then the maximum peak of [symbol] needs to be at 20 log(K)∈(−∞, 0) decibels.

### 2.3 Illustrative Numerical Example

In this example, the inventors consider the second-order linear time-invariant model of a DC motor with

$$A = [ \begin{matrix}0 & 1 \\ 0 & - 6.7797\end{matrix} ] , B = [ \begin{matrix}0 \\ 151.5254\end{matrix} ]$$

and x₀=[0.1, −0.1]^{T}, where the first and the second states respectively denote the angular displacement θ(t) in radians and the angular velocity \dot{θ}(t) in radians per second. Note that this identified DC motor model is also used for experiments in Section 4. Here, the inventors select K₁=[0.7071,0.0618], which is based on the linear quadratic regulator theory, and K₂=0.7071 for the control signal given in this section, where the inventors choose a square wave command in which its amplitude alternates at a steady frequency between ±6.2832 radians. For the norm-free event rule given in this section, the inventors choose ψ₁=0.7, ψ₂=0.7, and ψ₃=1.5, where these selections satisfy Assumption 1 for μ∈{5,25} when γ=40.

In terms of numerical results, the inventors obtained 99.32% reduction in control data transmissions without the disclosed corrective signal, and 99.02% and 97.82% reductions in control data transmissions with the disclosed corrective signal respectively for μ=5 and μ=25. Observe that the closed-loop system response approaches its ideal one as the inventors increase μ without sacrificing much from reduction in control data transmissions.

### 3 Performance Recovery in Output Feedback Event-Triggered Control

### 3.1 Problem Definition

Consider the linear time-invariant system given by (4) and

$$y ( t ) = Cx ( t ) ,$$

where C∈ [symbol] such that the pair (A, C) is observable and y(t)∈ [symbol] is a measurable output. For the results presented in this section, the inventors do not consider that the state x(t) of (4) is measurable. In addition, consider a continuous control signal

$$u ( t ) = - {K}_{1} \hat{x} ( t ) + {K}_{2} c ( t ) + δ ( t )$$

to generate its sampled data version uₛ(t), where \hat{x}(t)∈ [symbol] is the estimated state satisfying the dynamics given by

[symbol]

$$\dot{\hat{x}} ( t ) = A \hat{x} ( t ) + {Bu}_{s} ( t ) + L ( y ( t ) - C \hat{x} ( t ) ) + \frac{1}{{γ}_{1}} {S}^{- 1} PB ( δ ( t ) + ( {u}_{s} ( t ) - u ( t ) ) ) , \hat{x} ( 0 ) = {\hat{x}}_{0}$$

In (31), L∈ [symbol] is the estimator gain matrix with A₀≙A−LC being Hurwitz, γᵢ∈ [symbol] is the gain, and S∈

$${ℝ}_{+}^{n \times n}$$

is the solution to the Lyapunov equation

$$0 = {A}_{0}^{T} S + {SA}_{0} + I .$$

Adding and subtracting the term Bu(t) to (4), and then using (30), one can obtain the closed-loop system as

$$\dot{x} ( t ) = {A}_{r} x ( t ) + {B}_{r} c ( t ) + {BK}_{1} \tilde{x} ( t ) + B ( δ ( t ) + ( {u}_{s} ( t ) - u ( t ) ) ) ,$$

where \tilde{x}(t)≙x(t)−\hat{x}(t) is the estimation error that satisfies the dynamics given by

$$\dot{\tilde{x}} ( t ) = {A}_{0} \tilde{x} ( t ) - \frac{1}{{γ}_{1}} {S}^{- 1} PB ( δ ( t ) + ( {u}_{s} ( t ) - u ( t ) ) ) ,$$

$$\tilde{x} ( 0 ) = {\tilde{x}}_{0}$$

Once again, the aim of introducing the corrective signal δ(t) satisfying (7) is to suppress the effect of the mismatch term uₛ(t)−u(t) so that the resulting closed-loop system performance approaches to its ideal (i.e., non-event-triggered) one (i.e., (32) and (33) without the term δ(t)+(uₛ(t)−u(t))).

To schedule output feedback control data transmissions from (30) to (4), consider the norm-free event rule given by

$$2 {( \hat{x} ( t ) + {A}_{r}^{- 1} {B}_{r} c ( t ) )}^{T} PB ( δ ( t ) + ( {u}_{s} ( t ) - u ( t ) ) ) - 2 {μγ}_{2} {δ}^{T} ( t ) ( {u}_{s} ( t ) - u ( t ) ) \leq {{ϕ}_{1} ( \hat{x} ( t ) + {A}_{r}^{- 1} {B}_{r} c ( t ) )}^{T} ( \hat{x} ( t ) + {A}_{r}^{- 1} {B}_{r} c ( t ) ) + {ϕ}_{2} {δ}^{T} ( t ) δ ( t ) + {ϕ}_{3} ( t )$$

where γ₂∈ [symbol] , ϕ₁∈ [symbol] , ϕ₂∈ [symbol] , and ϕ₃(t)∈ [symbol] a bounded function of time. In addition, consider that the following assumption holds.

Assumption 2. The matrix given by

$$ℳ {=}^{Δ} [ \begin{matrix}( 1 - {ϕ}_{1} ) I & 0 & - {ℳ}_{0} \\ 0 & ( 2 μ {γ}_{2} - {ϕ}_{2} ) I & 0 \\ - {ℳ}_{0}^{T} & 0 & ( {γ}_{1} - {ϕ}_{1} ) I\end{matrix} ]$$

is positive-definite, where [symbol] [symbol] PBK₁−ϕ₁I.

The inventors can now give their problem definition for output feedback event-triggered control: Consider the system (4) and (29) with the control law (30) involving the disclosed corrective signal (7). Consider also the event rule (34) under Assumption 2. Their objective is to show the boundedness of the resulting closed-loop system, and its global exponential stability for the special case when the command is constant and ϕ₃(t)≡0 in the norm-free event rule (34) with performance recovery. Note that a discussion similar to the one presented in Remark 2 also applies to this problem definition.

### 3.2 System-Theoretical Analyses

The next theorem presents their third main result on the stability of the closed-loop system with the event triggered output feedback control architecture presented in Section 3.1. For this result, the time-derivative of the error signal (8) satisfies

$$\dot{e} ( t ) = {A}_{r} e ( t ) + {BK}_{1} \tilde{x} ( t ) + B ( δ ( t ) + ( {u}_{s} ( t ) - u ( t ) ) )$$

$$+ {A}_{r}^{- 1} {B}_{r} \dot{c} ( t ) , e ( 0 ) = {e}_{0} .$$

Theorem 3. Consider the linear time-invariant system (4) and (29) subject to the output feedback control law (30), which involves the disclosed corrective signal (7). Consider also the norm-free event rule (34) subject to Assumption 2. Then, the triple (e(t), δ(t), \tilde{x}(t)) is bounded according to

$${𝒱}_{2} ( \cdot ) \leq {V}_{2 , 0} exp ( - {r}_{0} t ) + {r}_{0}^{- 1} {r}_{1} ,$$

$$where$$

$${𝒱}_{2} ( e , δ , \tilde{x} ) {=}^{Δ} {e}^{T} Pe + {γ}_{2} {δ}^{T} δ + {γ}_{1} {\tilde{x}}^{T} S \tilde{x} ,$$

$${𝒱}_{2 , 0} {=}^{Δ} {e}_{0}^{T} {Pe}_{0} + {γ}_{1} {\tilde{x}}_{0}^{T} S {\tilde{x}}_{0} , {r}_{0} {=}^{Δ} min \{ ( \underline{λ} ( ℳ ) - \frac{1}{2 ϵ} ) / \underline{λ} ( P ) , ( \underline{λ} ( ℳ ) - \frac{1}{2 ϵ} ) / {γ}_{2} , ( \underline{λ} ( ℳ ) - \frac{1}{2 ϵ} ) / {γ}_{1} \underline{λ} ( S ) \} , {r}_{1} {=}^{Δ} \frac{ϵ}{2} {ϱ}^{T} ϱ + {\overline{ϕ}}_{3} , {ϕ}_{3} ( t ) \leq {\overline{ϕ}}_{3} , ϱ {=}^{Δ} {[ {( 2 {PA}_{r}^{- 1} {B}_{r} \overline{\dot{c}} )}^{T} , 0 , 0 ]}^{T} , {‖ \dot{c} ( t ) ‖}_{2} \leq \overline{\dot{c}}$$

and ϵ∈ [symbol] is an arbitrary constant satisfying

$$ℳ - \frac{1}{2 ϵ} I ∈ {ℝ}_{+}^{n \times n} .$$

If, in addition, the command is constant and ϕ₃(t)≡0 in (34), then the origin of the triple (e(t), δ(t), \tilde{x}(t)) is globally exponentially stable.

Proof. The time derivative of (38) satisfies

$${\dot{𝒱}}_{2} ( \cdot ) = - {e}^{T} ( t ) e ( t ) - 2 {γ}_{2} μ {δ}^{T} ( t ) δ ( t ) - {γ}_{1} {\tilde{x}}^{T} ( t ) \tilde{x} ( t ) + 2 {e}^{T} ( t ) {PBK}_{1} \tilde{x} ( t ) - 2 {γ}_{2} μ {δ}^{T} ( t ) ( {u}_{s} ( t ) - u ( t ) ) + 2 {e}^{T} ( t ) PB ( δ ( t ) + {u}_{S} ( t ) - u ( t ) ) + 2 {e}^{T} ( t ) {PA}_{r}^{- 1} \cdot {B}_{r} \dot{c} ( t ) - 2 {\tilde{x}}^{T} ( t ) PB ( δ ( t ) + {u}_{S} ( t ) - u ( t ) )$$

In the term

$$ζ ( \cdot ) {=}^{Δ} 2 {e}^{T} ( t ) PB ( δ ( t ) + {u}_{s} ( t ) - u ( t ) )$$

can be equivalently rewritten as

$$ζ ( \cdot ) = 2 {( x ( t ) + {A}_{r}^{- 1} {B}_{r} c ( t ) )}^{T} PB ( δ ( t ) + {u}_{S} ( t ) - u ( t ) ) = 2 {( \hat{x} ( t ) + {A}_{r}^{- 1} {B}_{r} c ( t ) )}^{T} PB ( δ ( t ) + {u}_{S} ( t ) - u ( t ) ) + 2 {\tilde{x}}^{T} ( t ) PB ( δ ( t ) + {u}_{s} ( t ) - u ( t ) )$$

Using (41) and the norm-free event rule (34) in (39) yields

$${\dot{𝒱}}_{2} ( \cdot ) \leq - ( 1 - {ϕ}_{1} ) {e}^{T} ( t ) e ( t ) - ( 2 {γ}_{2} μ - {ϕ}_{2} ) {δ}^{T} ( t ) δ ( t ) - ( {γ}_{1} - {ϕ}_{1} ) {\tilde{x}}^{T} ( t ) \tilde{x} ( t ) + 2 {e}^{T} ( t ) {PA}_{r}^{- 1} {B}_{r} \dot{c} ( t ) + {\overline{ϕ}}_{3} + 2 {e}^{T} ( t ) ( {PBK}_{1} - {ϕ}_{1} I ) \tilde{x} ( t ) \leq - {η}^{T} ( t ) ℳη ( t ) + {η}^{T} ( t ) ϱ + {\overline{ϕ}}_{3}$$

with η(t)≙[e^{T}(t),δ^{T}(t), \tilde{x}^{T}(t)]^{T}. Now, using Lemma 1 on the second term in (42) results in

$${\dot{𝒱}}_{2} ( \cdot ) \leq - {η}^{T} ( t ) ( ℳ - \frac{1}{2 ϵ} I ) η ( t ) + \frac{ϵ}{2} {ϱ}^{T} ϱ + {\overline{ϕ}}_{3}$$

$$\leq - ( \frac{\underline{λ} ( ℳ ) - \frac{1}{2 ϵ}}{\underline{λ} ( P )} ) {e}^{T} ( t ) Pe ( t ) + \frac{ϵ}{2} {ϱ}^{T} ϱ$$

$$- ( \frac{\underline{λ} ( ℳ ) - \frac{1}{2 ϵ}}{{γ}_{2}} ) {γ}_{2} {δ}^{T} ( t ) δ ( t ) + {\overline{ϕ}}_{3}$$

$$- ( \frac{\underline{λ} ( ℳ ) - \frac{1}{2 ϵ}}{{γ}_{1} ( S )} ) {γ}_{1} {\tilde{x}}^{T} ( t ) S \tilde{x} ( t )$$

$$\leq - {r}_{0} {𝒱}_{2} ( \cdot ) + {r}_{1} .$$

From Lemma 2, it now follows that the pair (e(t), δ(t), \tilde{x}(t)) is bounded according to (37). Finally, if the command is constant and ϕ₃(t)≡0, then r₁≡0 in (43). In this case, (37) reduces to [symbol] (⋅)≤ [symbol] exp(−r₀t), which gives global exponential stability of the origin of (e(t), δ(t), \tilde{x}(t)).

Remark 5. Note that (37) in Theorem 2 implies that \hat{\dot{x}}(t) is bounded from (31) and \dot{δ}(t) is bounded from (7). Thus, there is α∈ [symbol] such that

$$\frac{d}{dt} {‖ {u}_{s} ( t ) - u ( t ) ‖}_{2} \leq {‖ \frac{d}{dt} {u}_{s} ( t ) - \frac{d}{dt} u ( t ) ‖}_{2} = {‖ - {K}_{1} \dot{\hat{x}} ( t ) + {K}_{2} \dot{c} ( t ) + \dot{δ} ( t ) ‖}_{2} \leq α$$

a holds over t∈(tᵢ, tᵢ₊₁) Using this and

$${lim}_{t \to {t}_{i}^{+}} {‖ {u}_{s} ( t ) - u ( t ) ‖}_{2} = 0 ,$$

the inventors arrive (17) over t∈(tᵢ, tᵢ₊₁). Following similar steps taken after (17) in Remark 3, one can now conclude that Zeno behavior cannot occur when ϕ₃(t)≠0 in (34).

The next theorem presents their fourth main result on performance recovery, which shows that the closed-loop system performance approaches to its ideal one as the gain μ of the corrective signal (4) is increased. For this result, the inventors define the ideal closed-loop system performance according to

$${\dot{x}}_{r} ( t ) = {A}_{r} {x}_{r} ( t ) + {B}_{r} c ( t ) + {BK}_{1} {\tilde{x}}_{r} ( t ) , {x}_{r} ( 0 ) = {x}_{0} ,$$

$${\dot{\tilde{x}}}_{r} ( t ) = {A}_{0} {\tilde{x}}_{r} ( t ) , {\tilde{x}}_{r} ( 0 ) = {\tilde{x}}_{0} .$$

with xᵣ(t)∈ [symbol] being the ideal state and \tilde{x}ᵣ(t)∈ [symbol] being the ideal estimation error of the closed-loop system. The inventors are now ready to give the following result.

Theorem 4. Consider the closed-loop system given by (32) and (33), and the dynamics of the corrective signal given by (7). Consider also the norm-free event rule given by (34) subject to Assumption 2. Then, the closedloop system performance approaches its ideal one as μ is increased.

Proof. First, all signals appearing in (32), (33), and (7) are bounded for the norm-free event rule under Assumption 2 from Theorem 3. Next, define eᵣ(t)≙x(t)−xᵣ(t), which yields

$${\dot{e}}_{r} ( t ) = {A}_{r} {e}_{r} ( t ) + B \tilde{δ} ( t ) + {BK}_{1} \tilde{e} ( t ) , {e}_{r} ( 0 ) = 0 ,$$

with \tilde{e}(t)≙\tilde{x}(t)−\tilde{x}ᵣ(t) satisfying

$$\dot{\tilde{e}} ( t ) = {A}_{0} \tilde{e} ( t ) - \frac{1}{{γ}_{1}} {S}^{- 1} PB \tilde{δ} ( t ) , \tilde{e} ( 0 ) = 0 .$$

Here, eᵣ(t) (respectively, \tilde{e}(t)) is a bounded signal owing to Theorem 3 that captures the difference between the closed-loop system (32) (respectively, (33)) and the ideal closed-loop system (44) (respectively, (45)). Similar to the proof of Theorem 2, if the inventors show that eᵣ(t) (respectively, \tilde{e}(t)) approaches to zero as μ is increased, then this yields the performance of the closed-loop system given by (32) (respectively, (33)) approach its ideal one given by (44) (respectively, (45)).

From the proof of Theorem 2, the dynamics of the corrective signal given by (7) can be equivalently represented in Laplace domain as (21). In addition, the error \tilde{δ}(t)=δ(t)+(uₛ(t)−u(t)) can be further equivalently represented in Laplace domain as (23), where the output \tilde{Δ}(s) of the resulting high-pass filter [symbol] suppresses the effect of its input Uₛ(s)−U(s) over frequencies less than its cutoff frequency, which is μ radians per second.

Now, the inventors represent (47) in Laplace domain as

$$\tilde{E} ( s ) = {𝒫}_{0} ( s ) \tilde{Δ} ( s ) = {𝒫}_{0} ( s ) {𝒯}_{hp} ( s ) ( {U}_{s} ( s ) - U ( s ) )$$

$$where$$

$${𝒫}_{0} ( s ) {=}^{Δ} - \frac{1}{{γ}_{1}} {( sI - {A}_{0} )}^{- 1} {S}^{- 1} PB$$

has n poles strictly on the left half plane (i.e., the eigenvalues of the Hurwitz matrix A₀) and \tilde{E}(s)≙ [symbol] \tilde{e}(t)}. Observe from the strictly proper nature of [symbol] (s) [Chapter 4.3.1, 11] that the existence of a frequency ϵ₀∈ [symbol] is guaranteed such that the output \tilde{E}(s) of the transfer function [symbol] (s) suppresses the effect of its input \tilde{Δ}(s) over frequencies that are more than ξ₀ radians per second. Moreover, since this input depends on the high-pass filter according to \tilde{Δ}(s) [symbol] (s)(Uₛ(s)−U(s)), one can conclude from (48) that the output \tilde{E}(s) of the transfer function [symbol] suppresses the effect of its input Uₛ(s)−U(s) over the entire frequency range as μ gets larger than ξ₀. This means that the closed-loop system (33) approaches its ideal one (45) as μ is increased.

Finally, one can represent (46) in Laplace domain as

$${E}_{r} ( s ) = 𝒫 ( s ) \tilde{Δ} ( s ) + 𝒫 ( s ) {K}_{I} \tilde{E} ( s ) = 𝒫 ( s ) {𝒯}_{h p} ( s ) ( {U}_{s} ( s ) - U ( s ) ) + 𝒫 ( s ) {K}_{1} {𝒫}_{0} ( s ) {𝒯}_{h p} ( s ) ( {U}_{s} ( s ) - U ( s ) )$$

where Eᵣ(s)≙ [symbol] {eᵣ(t)}. From the last paragraph of the proof of Theorem 2, the output of the transfer function [symbol] suppresses the effect of its input Uₛ(s)−U(s) over the entire frequency range as μ gets larger than ξ. From the previous paragraph of this proof, the output of the transfer function [symbol] also suppresses the effect of its input Uₛ(s)−U(s) over the entire frequency range as μ gets larger than ξ₀. This means that the closed-loop system (32) approaches its ideal one (44) as μ is increased.

Remark 6. Theorem 4 shows performance recovery in event-triggered output feedback control with the disclosed corrective signal. On the selection of μ of this corrective signal, one can first construct Bode plots of the transfer functions [symbol] (s) and [symbol] (s) to respectively determine ξ₀ and ξ mentioned in the proof of this theorem. One can then construct Bode plots of the transfer function [symbol] (respectively, [symbol] + [symbol] appearing in (48) (respectively, (50)) for a family of μ selections with μ>ξ₀ (respectively, μ>max{ξ₀,ξ}). Similar to the discussion given in Remark 4, these Bode plots can aid in judiciously choosing μ without the need of making it sufficiently large.

### 3.3 Illustrative Numerical Example

In this example, the inventors consider the second-order linear time-invariant model of a DC motor with (28), C=[1,0], and x₀=[0.1, −0.1]^{T}. The inventors use the same K₁ and K₂ matrices as well as the same command reported in Section 2.3, where the inventors select L=[10.4128,4.2135]^{T} based on linear quadratic regulator theory and \hat{x}₀=[0,0]^{T}. For the norm-free event rule given in this section, the inventors choose ϕ₁=0.7, ϕ₂=0.7, and ϕ₃=0.3, where these selections satisfy Assumption 2 for μ∈{5,25} when (γ₁,γ₂)=(100,1).

In terms of numerical results, the inventors obtained 99.30% reduction in control data transmissions without the disclosed corrective signal, and 94.52% and 93.74% reductions in control data transmissions with the disclosed corrective signal respectively for μ=5 and μ=25. Observe that the closed-loop system response approaches its ideal one as the inventors increase μ without sacrificing much from reduction in control data transmissions.

### 4 Experimental Results

In this experiment, the inventors use the Quanser QUBE-Servo 2 platform, which is an integrated DC motor system operating at 1000 Hertz. The inventors consider a total experiment duration of 10 seconds, where this implies that 10000 control data transmissions occur without any event-triggering approach. The inventors have identified this DC motor system with a second-order linear-time invariant model subject to (28), where the first state (i.e., angular displacement θ(t) in radians) is measurable and the second state (i.e., angular velocity \dot{θ}(t) in radians per second) is not measurable. For this reason, the inventors consider Quanser QUBE-Servo 2 platform.

C=[1,0] and resort to the disclosed event-triggered output feedback control architecture reported in Section 3. To this end, the inventors use the same parameter selections from Section 3.3, where the inventors have slightly adjusted K₂ to allow better command following performance. For the normfree event rule given by (34), the inventors first choose i) ϕ₁=0.6, ϕ₂=0.6, and ϕ₃=0.3, and then ii)ϕ₁=0.7, ϕ₂=0.7, and ϕ₃=0.3, where these selections satisfy Assumption 2 for μ∈{5,25} when (γ₁, γ₂)=(100,1).

In terms of the experimental results for case i), the inventors obtained 87.81% reduction in control data transmissions without the disclosed corrective signal, and 94.28% and 92.08% reductions in control data transmissions with the disclosed corrective signal respectively for μ=5 and μ=25. In terms of the experimental results for case ii), the inventors obtained 91.93% reduction in control data transmissions without the disclosed corrective signal, and 78.63% and 93.44% reductions in control data transmissions with the disclosed corrective signal respectively for μ=5 and μ=25. For both cases, observe that the closed-loop system response approaches its ideal one as the inventors increase μ without sacrificing the reduction in control data transmissions.

Remark 7. It is anticipated that variations in the numerical and experimental closed-loop system performances may occur due to factors such as system uncertainties and unmodeled dynamics. Nonetheless, it is noteworthy that these variations vanish as the gain μ of the disclosed corrective signal is increased, which shows the robustness of this signal.

### Supplemental Example Experiments—Multiagent Placement to Spatiotemporal Points: A Finite-Time Distribution Control Protocol Over Directed Acyclic Graphs

A standard notation is used in this section, where [symbol] denotes the set of real numbers, [symbol] denotes the set of positive real numbers, [symbol] denotes the set of nonnegative real numbers, and “≙” denotes the equality by definition. Furthermore, [symbol] denotes a fixed, connected, and directed graph with [symbol] ={v₁, . . . , vₚ} and ε⊂ [symbol] respectively being a nonempty finite set of n nodes and a set of edges. If vᵢ receives information from vⱼ, then there is an edge rooted at node vⱼ and ended at node vᵢ and this neighboring relation is indicated with i˜j. In addition, a directed path from node vᵢ to node vⱼ is a sequence of successive edges in the form (vᵢ, vₚ), (vₚ, v_{q}), . . . , (v_{y}, vⱼ), where a directed graph [symbol] has a spanning tree if the union of the root nodes has a directed path to every other node in the graph [symbol] . In this disclosure, the inventors consider a fixed, connected, and directed acyclic graph [symbol] that models agent-to-agent information exchange, where the inventors also make the standard spanning tree assumption.

Problem Description. Consider a multiagent system with n agents over a fixed, connected, and directed acyclic graph [symbol] . Consider also n spatiotemporal points (pᵢ, Tᵢ) that each agent needs to visit, where Tⱼ is a user-defined time that is different for each agent. Within this setting, the spatiotemporal points (pᵢ, Tᵢ) are available only to the root agent(s) and the user-defined time Tᵢ of an agent i is available to that agent. In addition, the root agent(s) generates a bounded continuously-differentiable command signal c(t) with a bounded time rate of change that connects these points.

Remark 1. The following observations are now understood:

First, the inventors let Tᵢ be different for each agent in order to address the problem of multiagent placement in a sequential manner, where this is without loss of generality. If desired, one can choose the user-defined time of an agent δ seconds different than the user-defined time of another agent with δ being sufficiently small, where in this case the user-defined times of these agents become practically identical.

Second, the reason behind the spatiotemporal points being available only to the root agent(s) is because of the security of the operation since root agent(s).

Third, the user-defined time Tᵢ is available to the corresponding agent i before the execution of the proposed protocol presented below. If this is not desired, one can use the theory of multiplex networks to add another graph layer for the purpose of locally distributing the user-defined times Tᵢ.

Finally, the generation of the bounded continuously differentiable command signal c(t) of the root agent(s) also needs to be completed before the execution of the proposed protocol. Mathematically speaking, consider that the dynamics of each agent satisfies the form given by:

$${\dot{x}}_{i} ( t ) = {u}_{i} ( t ) , {x}_{i} ( 0 ) = {x}_{i 0} ,$$

where xᵢ(t)∈ [symbol] denotes the state and uᵢ(t)∈ [symbol] denotes the control signal of agent i, i=1, . . . , n. In addition, consider the multiagent placement control protocol of agent i, i=1, . . . , n, given by

$${u}_{i} ( t ) = \{ \begin{matrix}- \frac{α}{{T}_{i} - t} {f}_{i} ( {x}_{i} ( t ) , {\hat{x}}_{j} ( t ) , c ( t ) ) , & t < {T}_{i} \\ 0 , & t \geq {T}_{i}\end{matrix}$$

$${f}_{i} ( \cdot ) = {\sum }_{i ∼ j} ( {x}_{i} ( t ) - {\hat{x}}_{j} ( t ) ) + {k}_{i} ( {x}_{i} ( t ) - c ( t ) )$$

where α∈ [symbol] a gain chosen before the execution of this protocol and kᵢ=1 for the root agent(s) and otherwise kᵢ=0. In addition, \hat{x}ᵢ(t)∈ [symbol] is the virtual state of agent i, i=1, . . . , n, which satisfies

$${\dot{\hat{x}}}_{i} ( t ) = \{ \begin{matrix}- \frac{α}{{T}_{i} - t} {\hat{f}}_{i} ( {\hat{x}}_{i} ( t ) , {\hat{x}}_{j} ( t ) , c ( t ) ) , & t < {T}_{i} \\ - {β}_{1} sgn ( {\hat{f}}_{i} ( \cdot ) ) - {β}_{2} {\hat{f}}_{i} ( \cdot ) , & t \geq {T}_{i}\end{matrix}$$

$$\hat{{f}_{i}} ( \cdot ) = {\sum }_{i ∼ j} ( {\hat{x}}_{i} ( t ) - {\hat{x}}_{j} ( t ) ) + {k}_{i} ( {\hat{x}}_{i} ( t ) - c ( t ) )$$

where β₁∈ [symbol] and β₂∈ [symbol] are gains that are also chosen before the execution of this protocol.

Remark 2. If desired, one may use heterogeneous gains αᵢ∈ [symbol] , β₁ᵢ∈ [symbol] , and β₂ᵢ∈ [symbol] instead of homogeneous gains α,β₁, and β₂ in the proposed multiagent placement control protocol, with minimal modification to the algorithm.

The inventors are now ready to define the multiagent placement problem. Specifically:
i) The state xᵢ(t) of agent i approaches its spatiotemporal point (pᵢ, Tᵢ) at the user-defined time Tᵢ; that is,

$${lim}_{t \to {T}_{i}} ( {x}_{i} ( t ) - ( {p}_{i} , {T}_{i} ) ) = 0 , i = 1 , … , n$$

ii) The state xᵢ(t) of agent i stays at its spatial point (pᵢ, Tᵢ) over t∈[Tᵢ, ∞); that is,

$${x}_{i} ( t ) - ( {p}_{i} , {T}_{i} ) = 0 , t \geq {T}_{i} , i = 1 , … , n$$

iii) All closed-loop signals including the control signals of agents remain bounded for all time.
iv) The control signals of agents remain continuous at their switching instants.

While i) and ii) mathematically define the multiagent placement problem, the inventors also require iii) and iv) for the well-posedness of this problem. As described below, this problem is solvable with the proposed protocol when the following assumptions are satisfied.

Assumption 1. The user-defined time Tᵢ of node vᵢ is greater than the user-defined times of its neighbors in which this node receives information.

Assumption 2. The gains α and β₁ satisfy α(dᵢ+kᵢ)−1∈ [symbol] , where dᵢ is the degree of node i, i=1, . . . , n, and β₁>ċ̅, where |ċ(t)|≤ċ̅.

Assumption 3. At each switching instant, lim_{t→T}_{ᵢ}ċ(t)=0, i=1, . . . , n.

Remark 3. The following observations are now immediate. Specifically:

First, it is worth noting that Assumption 1 can be readily satisfied for a given fixed, connected, and directed acyclic graph [symbol] . To elucidate this point, consider the graph [symbol] in FIG. 2 as an example with nodes 1, 2, and 3 being root agents, where this graph clearly satisfies the spanning tree assumption. Consider now three exemplary cases a), b), and c) as boxed in this figure. For the agents belonging to case a), Assumption 1 implies that their user-defined times need to be selected as T₆>T₄>T₁. For the agents belonging to case b), it implies that T₇>T₅>T₂ and T₇>T₃, where the selection of T₃ does not impact the selection of T₂ and T₅. For the agents belonging to case c), it further implies that T₁₂>T₁₀>T₉ and T₁₂>T₁₁>T₉, where the selection of T₁₁ does not impact the selection of T₁₀ as long as both are greater than T₉. Here, T₉ also needs to be greater than both T₇ and T₈. A similar discussion can be given for all other agents on this graph [symbol] .

Second, Assumption 2 can also be readily satisfied for not only α but also β₁. Because, the root node(s) generate the bounded continuously-differentiable command signal c(t) before the execution of the proposed protocol, and therefore, they know the upper bound c or its conservative estimate that can be used to determine β₁, once again, before the execution of the proposed protocol. Note that Assumptions 1 and 2 are needed to address i), ii), and iii) below.

Finally, Assumption 3 is needed to address iv); that is, jumps in the control signals of agents occur when it does not hold. To satisfy this assumption, one needs to take into account the constraint ċ(Tᵢ)=0 while using the spline interpolation approach. As an example, this constraint is considered an example, where Assumption 3 holds for all points i=1, . . . , 8. (As opposed to fitting a single high-degree polynomial to all of the spatiotemporal points at once, which may result in over-fitting, spline interpolation is a scalable approach.

Remark 4. Below, it is shown that

$${u}_{i} ( t ) = - \frac{α}{{T}_{i} - t} {f}_{i} ( {x}_{i} ( t ) , {\hat{x}}_{j} ( t ) , c ( t ) ) t < {T}_{i}$$

allows to address i) and uᵢ(t)=0 t≥Tᵢ allows to address ii) under Assumptions 1, 2, and 3. However, it should be noted that uᵢ(t)=0 for t≥Tᵢ may not be a robust control selection when perturbations are present. To address this problem, one can consider, for example,

$${u}_{i} ( t ) = \{ \begin{matrix}- \frac{α}{{T}_{i} - t} {f}_{i} ( {x}_{i} ( t ) , {\hat{x}}_{j} ( t ) , c ( t ) ) , & t < {T}_{i} \\ - γ ( {x}_{i} ( t ) - {x}_{i} ( {T}_{i} ) ) , & t \geq {T}_{i}\end{matrix}$$

instead with γ∈ [symbol] , where xᵢ(Tᵢ)=(pᵢ, Tᵢ) from i). In this case, the results presented in this disclosure only experience minor modifications.

The inventors now present several system-theoretical analyses to address the problems i), ii), iii), and iv) defined above.

### Analysis for Problem i)

One aspect of this disclosure shows that the proposed multiagent placement control protocol addresses the problem i).

Theorem 1. Consider a multiagent system over a fixed, connected, and directed acyclic graph [symbol] , where the dynamics of each agent satisfies (1). Consider also the multiagent placement control protocol. If the user-defined times satisfy Assumption 1, then i) holds.

Proof. Let eᵢ(t)=xᵢ(t)−c(t) and êᵢ(t)=\hat{x}ᵢ(t)−c(t) respectively be the error and the virtual error signals of an agent i, i=1, . . . , n, over t∈[0, Tᵢ). In the remainder of the proof, the inventors show that i) holds in two cases.

Case 1. Since a fixed, connected, and directed acyclic graph [symbol] cannot contain directed cycles and because of the spanning tree consideration, there must exist at least one root agent that do not receive information from other agents. In this case, the error dynamics of that root agent satisfies

$${\dot{e}}_{i} ( t ) = - \frac{α}{{T}_{i} - t} {e}_{i} ( t ) - w ( t )$$

where w(t)≙ċ(t). Now, consider t=θ(sᵢ) with θ(sᵢ)≙Tᵢ(1−e^{-s}^{ᵢ}), where sᵢ∈[0, ∞) is the stretched time interval and θ′(sᵢ)≙dθ(sᵢ)/dsᵢ=Tᵢe^{-s}^{ᵢ}. In order to use the standard stability methods defined over the infinite time interval, one can transform the error dynamics from the regular time interval t∈[0, Tᵢ) to the stretched time interval sᵢ∈[0, ∞) according to

$${e}_{i}^{′} ( {s}_{i} ) = {θ}^{′} ( {s}_{i} ) ( - \frac{α}{{T}_{i} - {T}_{i} ( 1 - {e}^{- {s}_{i}} )} {e}_{i} ( {s}_{i} ) - w ( θ ( {s}_{i} ) ) ) = {T}_{i} {e}^{- {s}_{i}} ( - \frac{α}{{T}_{i} {e}^{- {s}_{i}}} {e}_{i} ( s ) - w ( θ ( {s}_{i} ) ) ) = - α {e}_{i} ( {s}_{i} ) - {T}_{i} {e}^{- {s}_{i}} w ( θ ( {s}_{i} ) )$$

where eᵢ(θ⁻¹(0))=eᵢ(0). Observe that this time transformation connects the solution over t∈[0, Tᵢ) and the solution over sᵢ∈[0, ∞) within each other as eᵢ(sᵢ)=eᵢ(t)|_{t=θ(s}_{ᵢ}₎, where θ(sᵢ) is strictly increasing and continuously differentiable. Therefore, if the inventors show limₛ_{ᵢ}_{→∞}eᵢ(sᵢ)=0, then this implies lim_{t→T}_{ᵢ}eᵢ(t)=0.

To this end, note that “Tᵢe^{-s}^{ᵢ}w(θ(sᵢ))” is a bounded and vanishing signal. Hence, the solution eᵢ(sᵢ)=eᵢ(t)|_{t=θ(s}_{ᵢ}₎ is input-to-state stable and limₛ_{ᵢ}_{→∞}eᵢ(sᵢ)=0 (i.e., lim_{t→T}_{ᵢ}eᵢ(t)=0), which implies that xᵢ(Tᵢ)=c(Tᵢ)=(pᵢ, Tᵢ). Finally, the virtual error dynamics of the aforementioned root agent satisfies

$${\dot{\hat{e}}}_{i} ( t ) = - \frac{α}{{T}_{i} - t} {\hat{e}}_{i} ( t ) - w ( t )$$

Because of the similarity, input-to state stability of êᵢ(t) and lim_{t→T}_{ᵢ}êᵢ(t)=0 are also immediate from the same steps taken above, which implies that \hat{x}ᵢ(Tᵢ)=c(Tᵢ)=(pᵢ, Tᵢ)

Case 2 Next, consider any agent from [symbol] other than the agent considered in Case 1 The following exemplary discussion is necessary:

First, consider the root agent 1 from [symbol] in FIG. 2. Clearly, lim_{t→T}_{₁}e₁(t)=0 and lim_{t→T}_{₁}ê₁(t)=0 from Case 1, where this case also implies the boundedness of both e₁(t) and ê₁(t) over t∈[0, T₁).

Theorem 3 also shows that êᵢ(t)=0 over t∈[Tᵢ, ∞) for any agent i, i=1, . . . , n, and hence, ê₁(t)=0 over t∈[T₁, ∞) for this root agent.

Second, consider agent 4 from the same [symbol] with its error and virtual error dynamics respectively satisfying

$${e}_{4}^{′} ( {s}_{4} ) = - α ( {e}_{4} ( {s}_{4} ) - {\hat{e}}_{1} ( {s}_{4} ) ) - {T}_{4} {e}^{- {s}_{4}} w ( θ ( {s}_{4} ) ) and$$

$${\hat{e}}_{4}^{′} ( {s}_{4} ) = - α ( {\hat{e}}_{4} ( {s}_{4} ) - {\hat{e}}_{1} ( {s}_{4} ) ) - {T}_{4} {e}^{- {s}_{4}} w ( θ ( {s}_{4} ) )$$

over the stretched time interval s₄ ∈[0, ∞), and recall that T₄>T₁ from Assumption 1. Note that ê₁(s₄)=ê₁(t)|_{t=θ(s}_{₄}₎ is bounded over t∈[0, T₁) and is zero over t∈[T₁, T₄) from the above bullet. Note also that “T₄e^{-s}^{₄}w(θ(s₄))” is a bounded and vanishing signal. Therefore, using input-to-state stability in these error and virtual error dynamics implies that e₄(s₄)=e₄(t)|_{t=θ(s}_{₄}₎ and ê₄(s₄)=ê₄(t)|_{t=θ(s}_{₄}₎ are bounded over t∈[0, T₁) and approach zero over t∈[T₁, T₄), which imply that x₄(T₄)=\hat{x}₄(T₄)=c(T₄)=p₄(T₄).

Third, consider agent 5 from the same [symbol] with its error and virtual error dynamics respectively satisfying

$${\hat{e}}_{5}^{′} ( {s}_{5} ) = - α ( 2 {\hat{e}}_{5} ( {s}_{5} ) - {\hat{e}}_{2} ( {s}_{5} ) - {\hat{e}}_{4} ( {s}_{5} ) ) - {T}_{5} {e}^{- {s}_{5}} w ( θ ( {s}_{5} ) ) and$$

$${\hat{e}}_{5}^{′} ( {s}_{5} ) = - α ( 2 {\hat{e}}_{5} ( {s}_{5} ) - {\hat{e}}_{2} ( {s}_{5} ) - {\hat{e}}_{4} ( {s}_{5} ) ) - {T}_{5} {e}^{- {s}_{5}} w ( θ ( {s}_{5} ) )$$

over the stretched time interval s₅∈[0, ∞), and recall that T₅>max{T₂, T₄} from Assumption 1. Note that ê₂(s₅)=ê₂(t)|_{t=θ(s}_{₅}₎ is bounded over t∈[0, T₂) using similar steps from Case 1 and is zero over t∈[T₂, T₅) from the first bullet, and ê₄(s₅)=ê₄(t)|_{t=θ(s}_{₅}₎ is bounded over t∈[0, T₄) from the above bullet and is zero over t∈[T₄, T₅) from the first bullet. Note also that “T₄e^{-s}^{₄}w(θ(s₄))” is a bounded and vanishing signal. Once again, using input-to-state stability in these error and virtual error dynamics implies that e₅(s₅)=e₅(t)|_{t=θ(s}_{₄}₎ and ê₅(s₄)=ê₅(t)|ₜ₌₀₍ₛ_{₅}₎ are bounded over t∈[0, max{T₂, T₄}) and approach zero over t∈[max{T₂, T₄}, T₅), which imply that x₅ (T₅)=\hat{x}₅(T₅)=c(T₅)=p₅(T₅).

Finally, one can sequentially apply the above steps to any other agent that belongs to the same [symbol] to show that i) holds (e.g., steps taken in the second bullet for agent 6 and steps taken in the third bullet for agent 8).

The above steps are not specific to [symbol] in FIG. 2. Specifically, consider any agent from some fixed, connected, and directed acyclic graph [symbol] other than the agent considered in Case 1, where this agent can also be a root agent. In this case, the error and virtual error dynamics of this agent satisfy

$${e}_{i}^{′} ( {s}_{i} ) = - α ( ( {d}_{i} + {k}_{i} ) {e}_{i} ( {s}_{i} ) - {\sum }_{i ∼ j} {\hat{e}}_{j} ( {s}_{i} ) )$$

$$- {T}_{i} {e}^{- {s}_{i}} w ( θ ( {s}_{i} ) )$$

$${e}_{i}^{′} ( {s}_{i} ) = - α ( ( {d}_{i} + {k}_{i} ) {e}_{i}^{′} ( {s}_{i} ) - {\sum }_{i ∼ j} {\hat{e}}_{j} ( {s}_{i} ) )$$

$$- {T}_{i} {e}^{- {s}_{i}} w ( θ ( {s}_{i} ) )$$

over the stretched time interval sᵢ∈[0, ∞). Now, recall that Tᵢ>Tₙᵢ from Assumption 1 with Tₙᵢ being the maximum user-defined time of the neighbors of node vᵢ in which this node receives information. Resorting to the same steps given above, any êⱼ(sᵢ)=êⱼ(t)|_{t=θ(s}_{ᵢ}_{) is bounded over t∈[}0, Tⱼ) and is zero over t∈[Tⱼ, T₁). Note also that “Tᵢe^{-s}^{ᵢ} w(θ(sᵢ))” is a bounded and vanishing signal. Using input-to-state stability implies that eᵢ(sᵢ)=eᵢ(t)|_{t=θ(s}_{ᵢ}₎ and êᵢ(sᵢ)=êᵢ(t)|_{t=θ(s}_{ᵢ}₎ are bounded over t∈[0, Tₙᵢ) and approach zero over t∈[Tₙᵢ, Tᵢ), which imply that xᵢ(Tᵢ)=\hat{x}ᵢ(Tᵢ)=c(Tᵢ)=(pᵢ, Tᵢ).

### B. Analysis for Problem ii)

A second aspect of this disclosure shows that the proposed multiagent placement control protocol addresses the problem ii).

Theorem 2. Consider a multiagent system over a fixed, connected, and directed graph [symbol] , where the dynamics of each agent satisfies (1). Consider also the multiagent placement control protocol. If the user defined times satisfy Assumption 1, then ii) holds.

Proof. Theorem 1 shows that the states of all agents approach their spatiotemporal points (pᵢ, Tᵢ) at the user defined times Tᵢ, i=1, . . . , n; that is. Since each agent uses uᵢ (t)=0 over t∈[Tᵢ, ∞), then \dot{x}ᵢ (t)=0 subject to xᵢ(Tᵢ)=(pᵢ, Tᵢ) holds over t∈[Tᵢ, ∞) with solution xᵢ(t)=(pᵢ, Tᵢ).

C. Analysis for Problem iii)

A third aspect of this disclosure shows that the proposed multiagent placement control protocol addresses the problem iii). To this end, the inventors first show the boundedness of all state and virtual state signals in Theorem 3. The inventors then show the boundedness of the control signals and the virtual control signals in Theorem 4.

Theorem 3. Consider a multiagent system over a fixed, connected, and directed graph [symbol] where the dynamics of each agent satisfies (1). Consider also the multiagent placement control protocol. If the user defined times satisfies Assumption 1 and the gain β₁ satisfies the condition in Assumption 2, then the state xᵢ(t) and the virtual state \hat{x}ᵢ(t) of agent i are bounded, and

$${\hat{x}}_{i} ( t ) - c ( t ) = 0 , t \geq {T}_{i} , i = 1 , … , n$$

Proof. The boundedness of the state xᵢ(t) and the virtual state \hat{x}ᵢ(t) of agent i, i=1, . . . , n, is shown in Theorem 1 over t∈[0, Tᵢ). In addition, the boundedness of the state xᵢ(t) of agent i, i=1, . . . , n, is shown in Theorem 2 over t∈[Tᵢ, ∞) (i.e., xᵢ(t)=(pᵢ, Tᵢ) over t∈[Tᵢ, ∞)). Therefore, the inventors only need to show the boundedness of the virtual state \hat{x}₁(t) of agent i, i=1, . . . , n, over t∈[Tᵢ, ∞) and to complete this proof. To this end, the inventors consider the following two cases.

Case 1. Similar to Case 1 given in the proof of Theorem 1, there must exist at least one root agent that does not receive information from other agents. In this case, the virtual error dynamics of that root agent satisfies

$${\dot{\hat{e}}}_{i} ( t ) = - {β}_{1} sgn ( {\hat{e}}_{i} ( t ) ) - {β}_{2} {\hat{e}}_{i} ( t ) - \dot{c} ( t )$$

where eᵢ(Tᵢ)=0 from Theorem 1. Now, consider the Lyapunov function candidate

$$𝒱 ( {\hat{e}}_{i} ) = {\hat{e}}_{i}^{2}$$

over t∈[Tᵢ, ∞), which has the time-derivative given by

$$\dot{𝒱} ( \cdot ) = 2 {\hat{e}}_{i} ( t ) ( - {β}_{1} sgn ( {\hat{e}}_{i} ( t ) ) - {β}_{2} {\hat{e}}_{i} ( t ) - \dot{c} ( t ) ) = - 2 {β}_{1} \vert {\hat{e}}_{i} ( t ) \vert - 2 {β}_{2} {\vert {\hat{e}}_{i} ( t ) \vert}^{2} - 2 {\hat{e}}_{i} ( t ) \dot{c} ( t )$$

Using Holder's Inequality for “2êᵢ(t)ċ(t)” results in

$$- 2 {\hat{e}}_{i} ( t ) \dot{c} ( t ) \leq \vert 2 {\hat{e}}_{i} ( t ) \vert \vert \dot{c} ( t ) \vert \leq 2 \vert {\hat{e}}_{i} ( t ) \vert \dot{\overline{c}}$$

where using and recalling β₁>ċ̅ from Assumption 2 yields

$$\dot{𝒱} ( \cdot ) \leq - 2 ( {β}_{1} - \overline{\dot{c}} ) \vert {\hat{e}}_{i} ( t ) \vert - 2 {β}_{2} {\vert {\hat{e}}_{i} ( t ) \vert}^{2} \leq - 2 {β}_{2} 𝒱 ( \cdot )$$

The boundedness of the virtual state \hat{x}ᵢ(t) of the aforementioned root agent is now immediate. Finally, using the comparison principle yields [symbol] (êᵢ(t))≤e^{-2β}^{₂}^{t} [symbol] (êᵢ(Tᵢ)), or equivalently, [symbol] (êᵢ(t))≤0, where is also immediate for that root agent.

Case 2. Next, consider any agent from [symbol] other than the agent considered in Case 1. The following exemplary discussion is necessary:

First, consider the root agent 1 from [symbol] in FIG. 2. Clearly, \hat{x}₁(t)=c(t) over t∈[Tᵢ, ∞) from Case 1.

Second, consider agent 4 from the same [symbol] and recall T₄>T₁ from Assumption 1. In this case, the virtual error dynamics of this agent satisfies ė₄(t)=−β₁sgn(ê₄(t)−ê₁(t))−β₂(ê₄(t)−ê₁(t))−ċ(t)=−β₁sgn(ê₄(t))−β₂ê₄(t)−ċ(t) over t∈[T₄, ∞) since ê₁(t)=0 over t∈[T₁, ∞) from the first bullet, where ê₄(T₄)=0 from Theorem 1. Now, following the same steps given in Case 1, the inventors arrive the boundedness of \hat{x}₄(t) and ê₄(t)=0 over t∈[T₄, ∞).

Third, consider agent 5 from the same [symbol] and recall T₅>max{T₂, T₄} from Assumption 1. In this case, the virtual error dynamics of this agent satisfies \hat{ė}₅(t)=−β₁sgn(ê₅(t)−ê₂(t)+ê₅(t)−ê₄(t))−β₂(ê₅(t)−ê₂(t)+ê₅(t)−ê₄(t))−ċ(t)=−β₁sgn(2ê₅(t))−2β₂ê₅(t)−ê₂(t) over t∈[T₅, ∞) since ê₂(t)=0 over t∈[T₂, ∞) using similar steps from Case 1 and ê₄(t)=0 over t∈[T₄, ∞) from the above bullet, where ê₅(T₅)=0 from Theorem 1. Now, noting sgn(2ê₅(t))=sgn(ê₅(t)) and following the same steps given in Case 1, the inventors arrive the boundedness of \hat{x}₅(t) and ê₅(t)=0 over t∈[T₅, ∞).

Finally, one can sequentially apply the above steps to any other agent that belongs to the same [symbol] to show the boundedness of its virtual state \hat{x}ᵢ(t) (e.g., steps taken in the second bullet for agent 6 and in the third bullet for agent 8).

The above steps are not specific to [symbol] in FIG. 2. Specifically, consider any agent from some fixed, connected, and directed acyclic graph [symbol] other than the agent considered in Case 1, where this agent can also be a root agent. In this case, the virtual error dynamics of this agent satisfy

$${\dot{\hat{e}}}_{i} ( t ) = - {β}_{1} sgn ( ( {d}_{i} + {k}_{i} ) {e}_{i} ( {s}_{i} ) - {\sum }_{i ∼ j} {\hat{e}}_{j} ( t ) ) - {β}_{2} ( ( {d}_{i} + {k}_{i} ) {e}_{i} ( t ) - {\sum }_{i ∼ j} {\hat{e}}_{j} ( t ) ) - \dot{c} ( t ) = - {β}_{1} sgn ( {e}_{i} ( {s}_{i} ) ) - ( {d}_{i} + {k}_{i} ) {β}_{2} {e}_{i} ( t ) - \dot{c} ( t )$$

over t∈[Tᵢ, ∞), since Σ_{i˜j}êⱼ(t)=0 over t∈[Tₙᵢ, ∞) resorting to the same steps given above with Tₙᵢ being the maximum user-defined time of the neighbors of node vᵢ in which this node receives information and sgn((dᵢ+kᵢ)eᵢ(sᵢ))=sgn(eᵢ(sᵢ)). Now, following the same steps given in Case 1, the inventors arrive the boundedness of \hat{x}ᵢ(t) and êᵢ (t)=0 over t∈[Tᵢ, ∞).

Theorem 4. Consider a multiagent system over a fixed, connected, and directed graph [symbol] where the dynamics of each agent satisfies (1). Consider also the multiagent placement control protocol. If the user defined times satisfy Assumption 1 and the gain α satisfies the condition in Assumption 2, then the control signal uᵢ(t) and the virtual control signal ûᵢ(t).

Proof. To show that the control signal uᵢ(t) and the virtual control signal ûᵢ(t) are bounded, the inventors consider the following two cases.

Case 1. Similar to Case 1 given in the proof of Theorem 1, there must exist at least one root agent that does not receive information from other agents. In this case, the control signal dynamics for that root agent satisfies

$${\dot{u}}_{i} ( t ) = - \frac{α}{{T}_{i} - t} ( {\dot{x}}_{i} ( t ) - \dot{c} ( t ) ) - \frac{α}{{( {T}_{i} - t )}^{2}} ( {x}_{i} ( t ) - c ( t ) ) = - \frac{α}{{T}_{i} - t} ( {u}_{i} ( t ) - \dot{c} ( t ) ) + \frac{1}{{T}_{i} - t} {u}_{i} ( t ) = - \frac{α - 1}{{T}_{i} - t} {u}_{i} ( t ) + \frac{α}{{T}_{i} - t} w ( t )$$

where can be equivalently represented over the stretched time interval sᵢ∈[0, ∞) as

$${u}_{i}^{′} ( {s}_{i} ) = - ( α - 1 ) {u}_{i} ( {s}_{i} ) + α w ( θ ( {s}_{i} ) )$$

If Assumption 2 holds with dᵢ=0 and kᵢ=1 for that root agent, then (α−1)∈ [symbol] . Hence, the solution uᵢ(sᵢ)=uᵢ(t)|_{t=θ(s}_{ᵢ}₎ is input-to-state stable, which yields to the boundedness of uᵢ (t) over t∈[0, Tᵢ) of that root agent. In addition, since uᵢ (t)=0 over t∈[T₁, ∞), one can conclude that the control signal uᵢ (t) of that root agent is bounded for all time.

Finally, the virtual control signal dynamics of the aforementioned root agent satisfies

$$x = y$$

Because of the similarity, one can also conclude that ûᵢ(t) is bounded over t∈[0, Tᵢ). Furthermore, since all virtual states are bounded by Theorems 1 and 3, t∈[T₁, ∞) and therefore, the virtual control signal ûᵢ(t) of that root agent is bounded for all time.

Case 2. Next, consider any agent from [symbol] other than the agent considered in Case 1. The following exemplary discussion is necessary:

First, consider the root agent 1 from [symbol] in FIG. 2. Clearly, u₁(t) and ûᵢ(t) are bounded for all time from Case 1.

Second, consider agent 4 from the same [symbol] with its control and virtual control signals dynamics respectively satisfying

$${u}_{4}^{′} ( {s}_{4} ) = - ( α - 1 ) {u}_{4} ( {s}_{4} ) + α {\hat{u}}_{1} ( {s}_{4} ) and$$

$${\hat{u}}_{4}^{′} ( {s}_{4} ) = - ( α - 1 ) {\hat{u}}_{4} ( {s}_{4} ) + α {\hat{u}}_{1} ( {s}_{4} )$$

over the stretched time interval s₄∈[0, ∞), and recall that T₄>T₁ from Assumption 1.

Note that û₁(s₄)=û₁(t)|_{t=0(S}_{₄}₎ is bounded over t∈[0, T₁) as well as t∈[Tᵢ, ∞) from the above bullet. If Assumption 2 holds with dᵢ=1 and kᵢ=0 for that agent, then (α−1)∈ [symbol] . Hence, the solutions u₄(s₄)=u₄(t)|ₜ₌ₑ₍ₛ_{₄}₎ and û₄(s₄)=û₄(t)|ₜ₌ₑ₍ₛ_{₄}₎ are input-tostate stable, which yields to the boundedness of u₄(t) and û₄(t) over t∈[0, T₄). Furthermore, since all virtual states are bounded by Theorems 1 and 3; t∈[T₄, ∞), and therefore, the control and the virtual control signals of that agent are bounded for all time.

Third, consider agent 5 from the same [symbol] with its control and virtual control signals dynamics respectively satisfying

$${u}_{5}^{′} ( {s}_{5} ) = - ( 2 α - 1 ) {u}_{5} ( {s}_{5} ) + α ( {\hat{u}}_{2} ( {s}_{5} ) + {\hat{u}}_{4} ( {s}_{5} ) ) and$$

$${u}_{5}^{′} ( {s}_{5} ) = - ( 2 α - 1 ) {\hat{u}}_{5} ( {s}_{5} ) + α ( {\hat{u}}_{2} ( {s}_{5} ) + {\hat{u}}_{4} ( {s}_{5} ) )$$

over the stretched time interval s₅∈[0, ∞), and recall that T₅>max{T₂, T₄} from Assumption 1. Note that û₂(s₅)=\dot{u}₂(t)|_{t=θ(s}_{₅}₎ is bounded over t∈[0, T₂) as well as t∈[T₂, ∞) using similar steps from Case 1, and û₄(s₅)=û₄(t)|_{t=θ(s}_{₅}₎ is bounded over t∈[0, T₄) as well as t∈[T₄, ∞) using similar steps from Case 1. If Assumption 2 holds with dᵢ=2 and kᵢ=0 for that agent, then (2α−1)∈ [symbol] . Hence, the solutions u₅(s₅)=u₅(t)|_{t=θ(s}_{₅}₎ and û₅(s₅)=û₅(t)|_{t=θ(s}_{₅}₎ are input-to-state stable, which yields to the boundedness of u₅(t) and û₅(t) over t∈[0, T₅). Furthermore, since all virtual states are bounded by Theorems 1 and 3; t∈[T₅, ∞), and therefore, the control and the virtual control signals of that agent are bounded for all time.

Finally, one can sequentially apply the above steps to any other agent that belongs to the same [symbol] to show the boundedness of its control signal uᵢ(t) and its virtual control signal ûᵢ(t) (e.g., steps taken in the second bullet for agent 6 and in the third bullet for agent 8).

The above steps are not specific to [symbol] in FIG. 2. Specifically, consider any agent from some fixed, connected, and directed acyclic graph g other than the agent considered in Case 1, where this agent can also be a root agent. In this case, the control dynamics and the virtual control dynamics of this agent respectively satisfy

$${u}_{i}^{′} ( {s}_{i} ) = - ( α ( {d}_{i} + {k}_{i} ) - 1 ) {u}_{i} ( {s}_{i} ) + α ( {\sum }_{i ∼ j} {\hat{u}}_{j} ( {s}_{i} ) + {k}_{i} w ( {s}_{i} ) )$$

$${\hat{u}}_{i}^{′} ( {s}_{i} ) = - ( α ( {d}_{i} + {k}_{i} ) - 1 ) {\hat{u}}_{i} ( {s}_{i} ) + α ( {\sum }_{i ∼ j} {\hat{u}}_{j} ( {s}_{i} ) + {k}_{i} w ( {s}_{i} ) )$$

over the stretched time interval sᵢ∈[0, ∞). Now, recall that Tᵢ>Tₙᵢ from Assumption 1 with Tₙᵢ being the maximum user-defined time of the neighbors of node vᵢ in which this node receives information. Resorting to the same steps given above, any uⱼ(sᵢ)=uⱼ(t)|_{t=θ(s}_{ᵢ}₎ and ûⱼ(sᵢ)=ûⱼ(t)|_{t=θ(s}_{ᵢ}₎ are bounded over t∈[0, Tⱼ) as well as t∈[Tⱼ, ∞). Using the input-to-state stability in (23) and (24) implies that u₁(sᵢ)=uᵢ(t)|_{t=θ(s}_{ₛ}₎ and ûᵢ(sᵢ)=ûᵢ(t)|_{t=θ(s}_{ᵢ}₎ are bounded over t∈[0, Tᵢ). Furthermore, since uᵢ(t)=0 t∈[Tᵢ, ∞), the control signal uᵢ(t) is bounded for all time. Finally, since all virtual states are bounded by Theorem 1 and Theorem 3, t∈[Tᵢ, ∞) is bounded. Hence, the virtual control signal ûᵢ(t) is bounded for all time.

Remark 5. Theorem 4 shows that the control signal uᵢ(t) and the virtual control signal ûᵢ(t) of agent i, i=1, . . . , n, are bounded. If one prefers to avoid these signals from taking large values as t approaches Tᵢ because of the presence of the term

$$“ \frac{1}{{T}_{i} - t} ”$$

then this term can be saturated over t∈[Tₛᵢ, Tᵢ) as

$$“ \frac{1}{{T}_{i} - {T}_{s i}} ”$$

for some Tₛᵢ<Tᵢ.

### D. Analysis for Problem iv)

A fourth aspect of this disclosure shows that the proposed multiagent placement control protocol addresses the problem iv).

Theorem 5. Consider a multiagent system over a fixed, connected, and directed graph [symbol] where the dynamics of each agent satisfies (1). Consider also the multiagent placement control protocol. If Assumptions 1 holds, then iv) holds.

Proof. First, consider the virtual state of agent i over t∈[Tᵢ, ∞), which is given by the second line the fourth equation. By adding and subtracting “c(t)” to the fifth equation, one can obtain

$${\hat{x}}_{i} ( t ) = - {β}_{1} sgn ( \hat{{f}_{i}} ( \cdot ) ) - {β}_{2} \hat{{f}_{i}} ( \cdot ) , t \geq {T}_{i} ,$$

$$\hat{{f}_{i}} ( \cdot ) = {\sum }_{i ∼ j} ( {\hat{e}}_{i} ( t ) - {\hat{e}}_{j} ( t ) ) + {k}_{i} {\hat{e}}_{i} ( t ) .$$

From Theorem 3, note that êᵢ(t)=0 over t∈[Tᵢ, ∞). Recalling that Tᵢ>Tₙᵢ from Assumption 1 with Tₙᵢ being the maximum user-defined time of the neighbors of node vᵢ in which this node receives information, one can arrive that êⱼ(t)=0 over t∈[Tₙᵢ, ∞) from Theorem 3 as well. Finally, one can conclude that \hat{\dot{x}}ᵢ(t)=0 over t∈[Tᵢ, ∞), which yields ûᵢ(t)=0 over t∈[Tᵢ, ∞) since \hat{\dot{x}}ᵢ(t)=ûᵢ(t).

Next, consider the control signal dynamics given by twenty third equation. When Assumption 3 holds, w(sᵢ) vanishes as sᵢ approaches ∞. Following the discussion given above, lim_{t→T}_{ᵢ}ûᵢ(t)=0 implies that lim_{s→∞}Σ_{i˜j}ûⱼ(sᵢ)=0. Hence, lim_{t→T}_{ᵢ}uᵢ(t)=0 from. Finally, since uᵢ(t)=0 over t∈[Tᵢ, ∞) as given by (2), the control signals of agents remain continuous at t=Tᵢ seconds.

### IV. Illustrative Numerical Examples

Two illustrative numerical examples are given, to demonstrate the efficacy of the multiagent placement control protocol described above. In the first example, the inventors consider eight agents (i.e., n=8) over a fixed, connected, and directed path graph [symbol] with the first agent being the root agent. The spatiotemporal points (pᵢ, Tᵢ) are chosen as the ones shown in FIG. 1, where the root agent uses the generated command also shown in the same figure. The inventors also choose α=2, β₁=4, and β₂=4, where initial conditions of all agents are randomly chosen from the interval (−1,1). Note that Assumptions 1, 2, and 3 hold, and the inventors approximate sgn(x) as tanh(ρx) with ρ=50 to avoid the chattering phenomenon in the control signals of agents. FIG. 3 shows the state and control histories of the multiagent system. As expected from the system-theoretical analyses presented above, the proposed protocol successfully achieves i), ii), iii), and iv).

In the second example, the inventors demonstrate that the proposed multiagent placement control protocol can be applied to a multiple-dimensional problem as-is. Specifically, the inventors consider twelve agents (i.e., n=12) over the fixed, connected, and directed graph [symbol] shown in FIG. 2 with the first three agents being the root agents. The spatiotemporal points (pᵢ, Tᵢ) are chosen at equal distances for each agent on a circle with a 4-unit radius. The inventors also choose α=2, β₁=5, and β₂=5, where initial conditions of all agents are randomly chosen from the interval (−1,1). Note that Assumptions 1, 2, and 3 hold, and the inventors approximate sgn(x) as tanh(ρx) with ρ=50 to avoid the chattering phenomenon in the control signals of agents. FIG. 4 shows the state histories of the multiagent system. Once again, as expected from the system-theoretical analyses presented above, the proposed protocol successfully achieves i), ii), iii), and iv).

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for operating a multi-agent system via control signals that preserve constraints of zone allocations of the system, comprising:
providing a group of agents to collectively comprise the multi-agent system, the agents configured to perform functions within designated zones and to communicate via a given peer to peer command protocol;
detecting a circumstance warranting a given command to be sent to a given agent, the command comprising a time-varying target state for the given agent;
determining a current, bounded zone allocation for the given agent, the bounded zone allocation including a constraint defining a region within which a state of the given agent is to be maintained during operation of the multi-agent system;
determining a current role and a current state of the given agent within the bounded zone allocation, based on at least one of a sensor output or information provided by one or more agents of the multi-agent system;
transforming the current state of the given agent from the bounded zone allocation to an unconstrained representation using a monotonically increasing aligned diffeomorphic (mia-diffeomorphic) map;
generating a virtual control signal for the given agent to implement the command, using a distributed adaptive control protocol and the unconstrained representation of the given agent's current state;
transforming the virtual control signal into an actual control signal for the given agent by applying an inverse of a derivative of the mia-diffeomorphic map to the virtual control signal;
transmitting the actual control signal for execution by the given agent, via a transmission formatted according to the current role of the given agent and the command protocol of the multi-agent system;
observing the given agent's behavior to confirm implementation of the command, such that if the command signal is within the bounded zone allocation the agent should be observed moving to the command, and if the command signal is not within the bounded zone allocation the agent should be observed maintaining proximity to the command signal while remaining within the bounded zone allocation; and
updating a zone allocation of at least one agent of the system based on the given agent behavior.

2. The method of claim 1, wherein the mia-diffeomorphic map comprises a smooth, invertible, and order-preserving mapping that matches an identity function within an interior portion of the bounded zone allocation.

3. The method of claim 1, wherein the multi-agent system comprises a group of drones and the zone allocation comprises a region in space within which the given agent must remain.

4. The method of claim 3, wherein the zone allocation is dynamically-defined according to a relative position of at least one other agent of the multi-agent system.

5. The method of claim 1, wherein the circumstance warranting the given command comprises a sensed object within an environment of the multi-agent system, and the command instructs the given agent to move toward the object within the given agent's zone allocation.
